(19) United States
(12) Patent Application Publication
(10) Pub. No.: US 2023/0275737 A1
(43) Pub. Date: Aug. 31, 2023

(54) ENHANCED INTERFERENCE MITIGATION FOR SOUNDING REFERENCE SIGNAL

(71) Applicant: QUALCOMM Incorporated, San Diego, CA (US)

(72) Inventors: Yitao CHEN, San Diego, CA (US); Mostafa KHOSHNEVISAN, San Diego, CA (US); Xiaoxia ZHANG, San Diego, CA (US); Jing SUN, San Diego, CA (US)

(21) Appl. No.: 18/167,621

(22) Filed: Feb. 10, 2023

Related U.S. Application Data
(60) Provisional application No. 63/268,549, filed on Feb. 25, 2022.

(51) Int. Cl. H04L 5/00; H04W 28/18; H04W 16/14

(52) U.S. Cl. CPC H04L 5/0094; H04L 5/0051; H04W 28/18; H04W 16/14

(57) ABSTRACT

Various aspects of the present disclosure generally relate to wireless communication. In some aspects, a user equipment (UE) may receive a configuration of a sounding reference signal (SRS) resource, wherein the configuration indicates a sequence index value for a base sequence for the SRS resource or the configuration indicates that the SRS resource is configured with group hopping and sequence hopping. The UE may transmit an SRS in the SRS resource in accordance with the configuration of the SRS resource. Numerous other aspects are described.

### CROSS-REFERENCE TO RELATED APPLICATION

This patent application claims priority to U.S. Provisional Patent Application No. 63/268,549, filed on Feb. 25, 2022, entitled “ENHANCED INTERFERENCE MITIGATION FOR SOUNDING REFERENCE SIGNAL,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for enhanced interference mitigation for sounding reference signal (SRS).

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive a configuration of a sounding reference signal (SRS) resource, wherein the configuration indicates a sequence index value for a base sequence for the SRS resource or the configuration indicates that the SRS resource is configured with group hopping and sequence hopping. The one or more processors may be configured to transmit an SRS in the SRS resource in accordance with the configuration of the SRS resource.

Some aspects described herein relate to a network entity for wireless communication. The network entity may include a memory and one or more processors coupled to the memory. The one or more processors may be configured to transmit a configuration of an SRS resource for a UE, wherein the configuration indicates a sequence index value for a base sequence for the SRS resource or the configuration indicates that the SRS resource is configured with group hopping and sequence hopping. The one or more processors may be configured to receive an SRS in the SRS resource in accordance with the configuration of the SRS resource.

Some aspects described herein relate to a method of wireless communication performed by a UE. The method may include receiving a configuration of an SRS resource, wherein the configuration indicates a sequence index value for a base sequence for the SRS resource or the configuration indicates that the SRS resource is configured with group hopping and sequence hopping. The method may include transmitting an SRS in the SRS resource in accordance with the configuration of the SRS resource.

Some aspects described herein relate to a method of wireless communication performed by a network entity. The method may include transmitting a configuration of an SRS resource for a UE, wherein the configuration indicates a sequence index value for a base sequence for the SRS resource or the configuration indicates that the SRS resource is configured with group hopping and sequence hopping. The method may include receiving an SRS in the SRS resource in accordance with the configuration of the SRS resource.

Some aspects described herein relate to a non-transitory computer-readable medium that stores a set of instructions for wireless communication by a UE. The set of instructions, when executed by one or more processors of the UE, may cause the UE to receive a configuration of an SRS resource, wherein the configuration indicates a sequence index value for a base sequence for the SRS resource or the configuration indicates that the SRS resource is configured with group hopping and sequence hopping. The set of instructions, when executed by one or more processors of the UE, may cause the UE to transmit an SRS in the SRS resource in accordance with the configuration of the SRS resource.

Some aspects described herein relate to a non-transitory computer-readable medium that stores a set of instructions for wireless communication by a network entity. The set of instructions, when executed by one or more processors of the network entity, may cause the network entity to transmit a configuration of an SRS resource for a UE, wherein the configuration indicates a sequence index value for a base sequence for the SRS resource or the configuration indicates that the SRS resource is configured with group hopping and sequence hopping. The set of instructions, when executed by one or more processors of the network entity, may cause the network entity to receive an SRS in the SRS resource in accordance with the configuration of the SRS resource.

Some aspects described herein relate to an apparatus for wireless communication. The apparatus may include means for receiving a configuration of an SRS resource, wherein the configuration indicates a sequence index value for a base sequence for the SRS resource or the configuration indicates that the SRS resource is configured with group hopping and sequence hopping. The apparatus may include means for transmitting an SRS in the SRS resource in accordance with the configuration of the SRS resource.

Some aspects described herein relate to an apparatus for wireless communication. The apparatus may include means for transmitting a configuration of an SRS resource for a UE, wherein the configuration indicates a sequence index value for a base sequence for the SRS resource or the configuration indicates that the SRS resource is configured with group hopping and sequence hopping. The apparatus may include means for receiving an SRS in the SRS resource in accordance with the configuration of the SRS resource.

Some aspects described herein relate to a UE for wireless communication. The UE may include a memory and one or more processors coupled to the memory. The one or more processors may be configured to receive a configuration of parameters for an SRS resource of an SRS resource set. The one or more processors may be configured to receive a dynamic indication of an updated value for at least one of the parameters for the SRS resource. The one or more processors may be configured to transmit an SRS in the SRS resource in accordance with the updated value for the at least one of the parameters for the SRS resource.

Some aspects described herein relate to a network entity for wireless communication. The network entity may include a memory and one or more processors coupled to the memory. The one or more processors may be configured to transmit a configuration of parameters for an SRS resource of an SRS resource set for a UE. The one or more processors may be configured to transmit a dynamic indication of an updated value for at least one of the parameters for the SRS resource. The one or more processors may be configured to receive an SRS in the SRS resource in accordance with the updated value for the at least one of the parameters for the SRS resource.

Some aspects described herein relate to a method of wireless communication performed by a UE. The method may include receiving a configuration of parameters for an SRS resource of an SRS resource set. The method may include receiving a dynamic indication of an updated value for at least one of the parameters for the SRS resource. The method may include transmitting an SRS in the SRS resource in accordance with the updated value for the at least one of the parameters for the SRS resource.

Some aspects described herein relate to a method of wireless communication performed by a network entity. The method may include transmitting a configuration of parameters for an SRS resource of an SRS resource set for a UE. The method may include transmitting a dynamic indication of an updated value for at least one of the parameters for the SRS resource. The method may include receiving an SRS in the SRS resource in accordance with the updated value for the at least one of the parameters for the SRS resource.

Some aspects described herein relate to a non-transitory computer-readable medium that stores a set of instructions for wireless communication by a UE. The set of instructions, when executed by one or more processors of the UE, may cause the UE to receive a configuration of parameters for an SRS resource of an SRS resource set. The set of instructions, when executed by one or more processors of the UE, may cause the UE to receive a dynamic indication of an updated value for at least one of the parameters for the SRS resource. The set of instructions, when executed by one or more processors of the UE, may cause the UE to transmit an SRS in the SRS resource in accordance with the updated value for the at least one of the parameters for the SRS resource.

Some aspects described herein relate to a non-transitory computer-readable medium that stores a set of instructions for wireless communication by a network entity. The set of instructions, when executed by one or more processors of the network entity, may cause the network entity to transmit a configuration of parameters for an SRS resource of an SRS resource set for a UE. The set of instructions, when executed by one or more processors of the network entity, may cause the network entity to transmit a dynamic indication of an updated value for at least one of the parameters for the SRS resource. The set of instructions, when executed by one or more processors of the network entity, may cause the network entity to receive an SRS in the SRS resource in accordance with the updated value for the at least one of the parameters for the SRS resource.

Some aspects described herein relate to an apparatus for wireless communication. The apparatus may include means for receiving a configuration of parameters for an SRS resource of an SRS resource set. The apparatus may include means for receiving a dynamic indication of an updated value for at least one of the parameters for the SRS resource. The apparatus may include means for transmitting an SRS in the SRS resource in accordance with the updated value for the at least one of the parameters for the SRS resource.

Some aspects described herein relate to an apparatus for wireless communication. The apparatus may include means for transmitting a configuration of parameters for an SRS resource of an SRS resource set for a UE. The apparatus may include means for transmitting a dynamic indication of an updated value for at least one of the parameters for the SRS resource. The apparatus may include means for receiving an SRS in the SRS resource in accordance with the updated value for the at least one of the parameters for the SRS resource.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of sounding reference signal (SRS) resource sets, in accordance with the present disclosure.

FIGS. 6-7 are diagrams illustrating examples associated with enhanced interference mitigation for SRS, in accordance with the present disclosure.

FIGS. 8-11 are diagrams illustrating example processes associated with enhanced interference mitigation for SRS, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

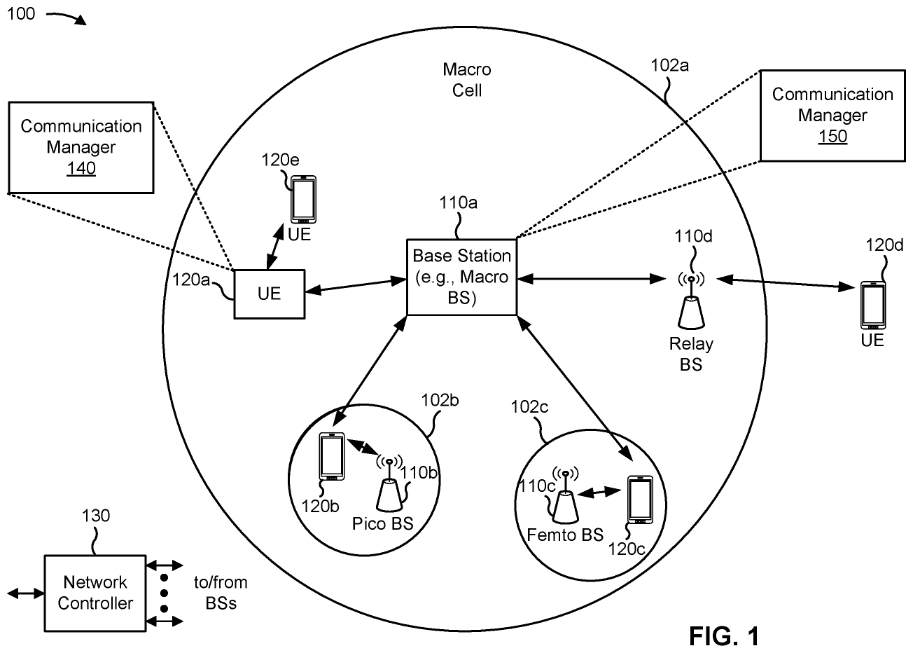

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay network node, a relay node, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link or a midhaul communication link. The base stations 110 may communicate with one another directly or indirectly via a wireless or wireline backhaul communication link. In some aspects, the network controller 130 may be a central or centralized unit (CU) or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a sounding reference signal (SRS) resource, wherein the configuration indicates a sequence index value for a base sequence for the SRS resource or the configuration indicates that the SRS resource is configured with group hopping and sequence hopping; and transmit an SRS in the SRS resource in accordance with the configuration of the SRS resource. Additionally, or alternatively, the communication manager 140 may perform one or more other operations described herein.

In some aspects, as described in more detail elsewhere herein, the communication manager 140 may receive a configuration of parameters for an SRS resource of an SRS resource set; receive a dynamic indication of an updated value for at least one of the parameters for the SRS resource; and transmit an SRS in the SRS resource in accordance with the updated value for the at least one of the parameters for the SRS resource. Additionally, or alternatively, the communication manager 140 may perform one or more other operations described herein.

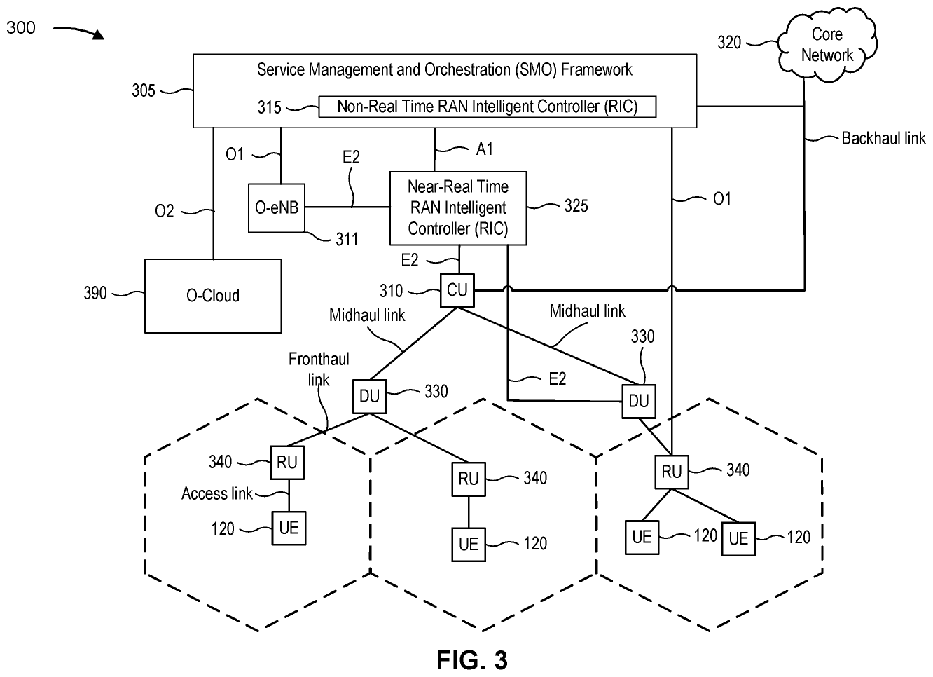

In some aspects, a network entity (e.g., a base station 110 or one or more components described in connection with FIG. 3) may include a communication manager 150. As described in more detail elsewhere herein, the communication manager 150 may transmit a configuration of an SRS resource for a UE, wherein the configuration indicates a sequence index value for a base sequence for the SRS resource or the configuration indicates that the SRS resource is configured with group hopping and sequence hopping; and receive an SRS in the SRS resource in accordance with the configuration of the SRS resource. Additionally, or alternatively, the communication manager 150 may perform one or more other operations described herein.

In some aspects, as described in more detail elsewhere herein, the communication manager 150 may transmit a configuration of parameters for an SRS resource of an SRS resource set for a UE; transmit a dynamic indication of an updated value for at least one of the parameters for the SRS resource; and receive an SRS in the SRS resource in accordance with the updated value for the at least one of the parameters for the SRS resource. Additionally, or alternatively, the communication manager 150 may perform one or more other operations described herein.

As indicated above, FIG. 1 is provided as an example. Other examples may differ from what is described with regard to FIG. 1.

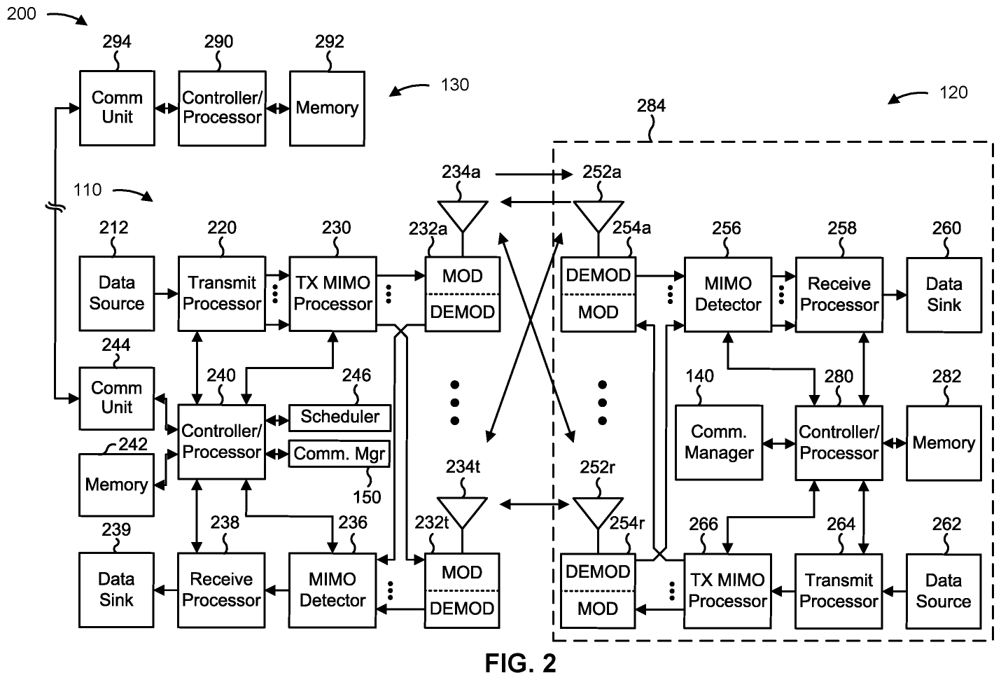

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

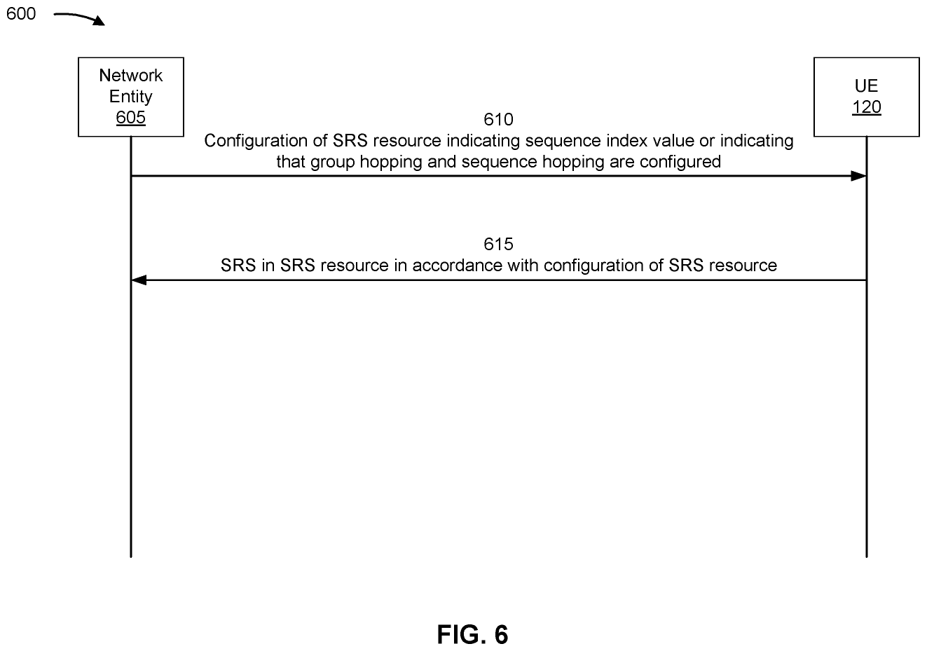

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

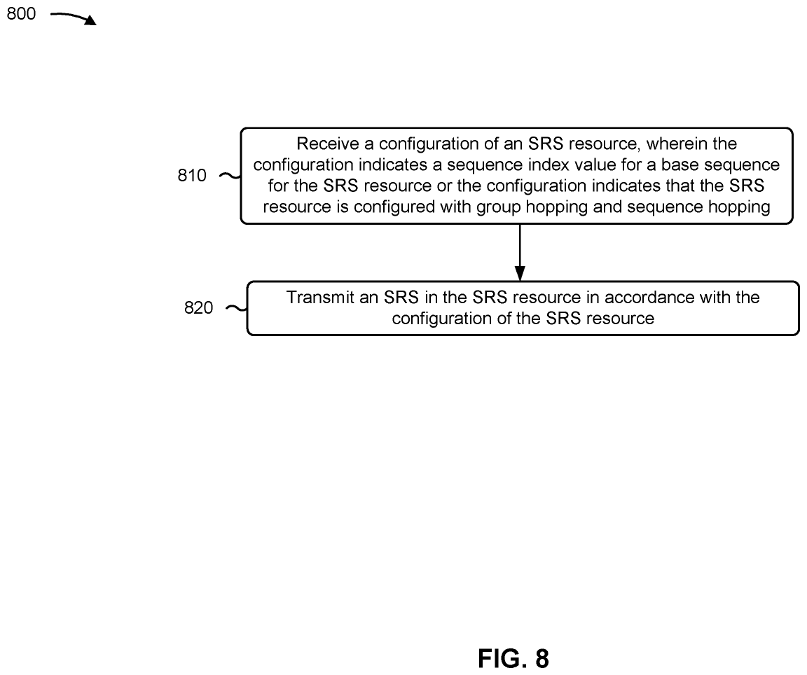

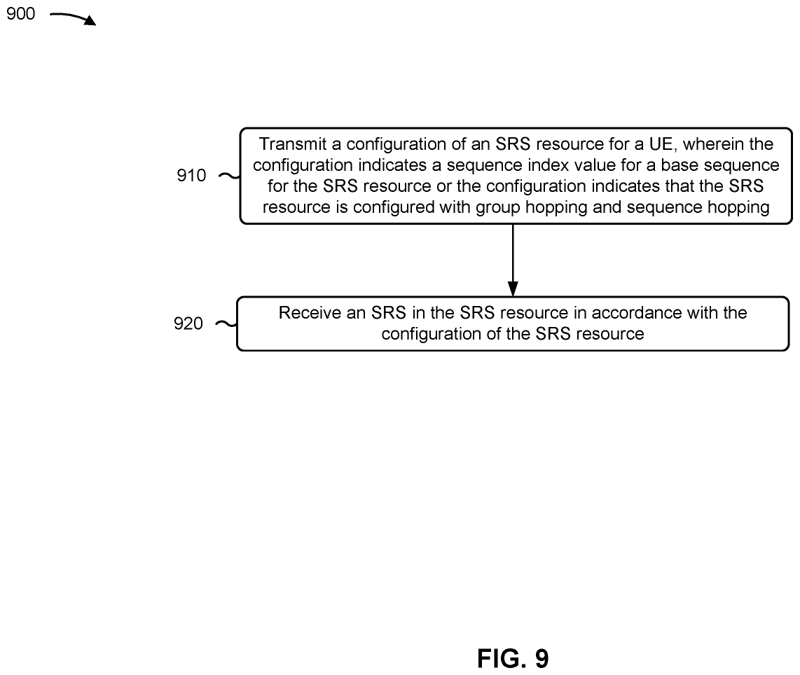

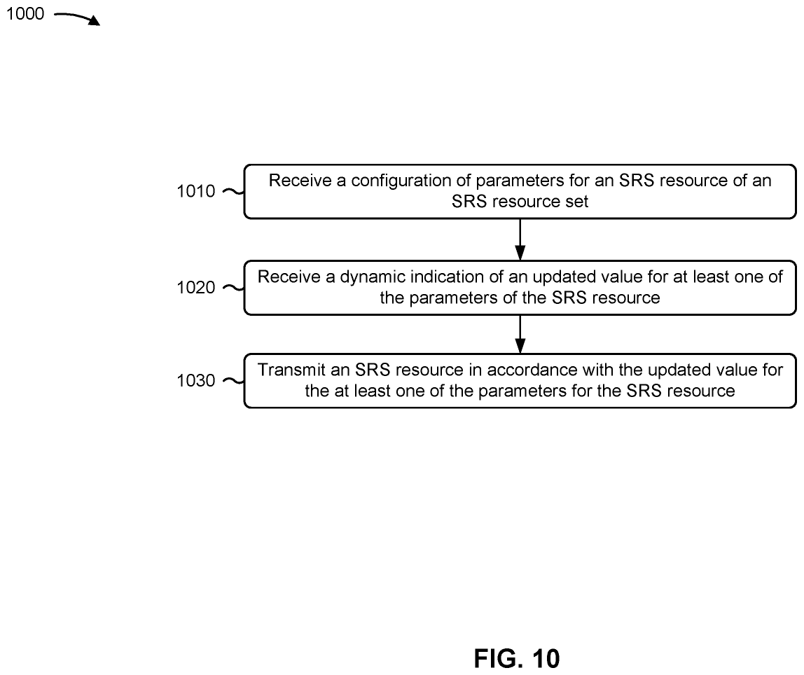

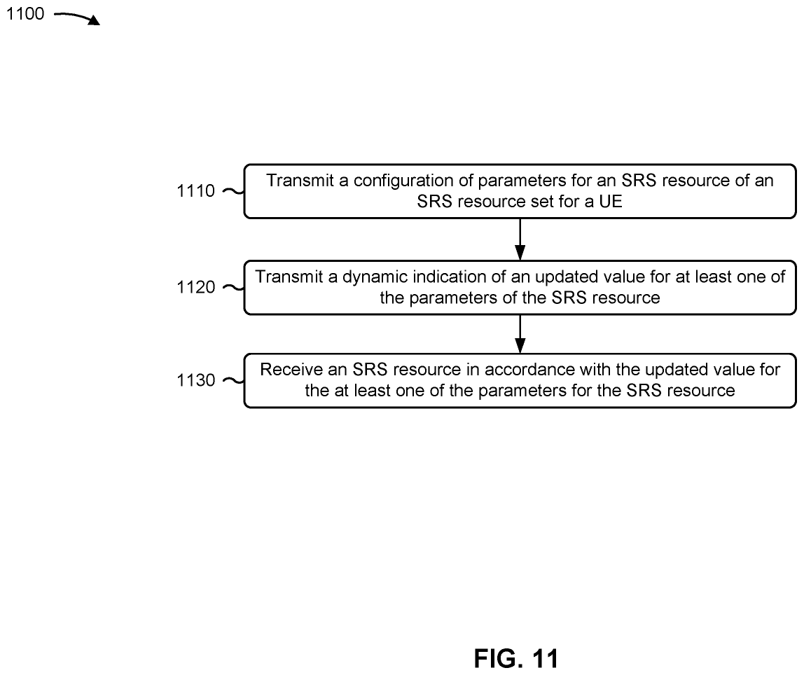

The controller/processor 240 of the base station 110, the controller/processor 280 of the UE 120, and/or any other component(s) of FIG. 2 may perform one or more techniques associated with enhanced interference mitigation for SRS, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples. In some aspects, a network entity described herein is the base station 110, is included in the base station 110, or includes one or more components of the base station 110 shown in FIG. 2.

In some aspects, the UE 120 includes means for receiving a configuration of an SRS resource, wherein the configuration indicates a sequence index value for a base sequence for the SRS resource or the configuration indicates that the SRS resource is configured with group hopping and sequence hopping; and/or means for transmitting an SRS in the SRS resource in accordance with the configuration of the SRS resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving a configuration of parameters for an SRS resource of an SRS resource set; means for receiving a dynamic indication of an updated value for at least one of the parameters for the SRS resource; and/or means for transmitting an SRS in the SRS resource in accordance with the updated value for the at least one of the parameters for the SRS resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for transmitting a configuration of an SRS resource for a UE, wherein the configuration indicates a sequence index value for a base sequence for the SRS resource or the configuration indicates that the SRS resource is configured with group hopping and sequence hopping; and/or means for receiving an SRS in the SRS resource in accordance with the configuration of the SRS resource. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network entity includes means for transmitting a configuration of parameters for an SRS resource of an SRS resource set for a UE; means for transmitting a dynamic indication of an updated value for at least one of the parameters for the SRS resource; and/or means for receiving an SRS in the SRS resource in accordance with the updated value for the at least one of the parameters for the SRS resource. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more distributed units (DUs), or one or more radio units (RUs)). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface).

For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

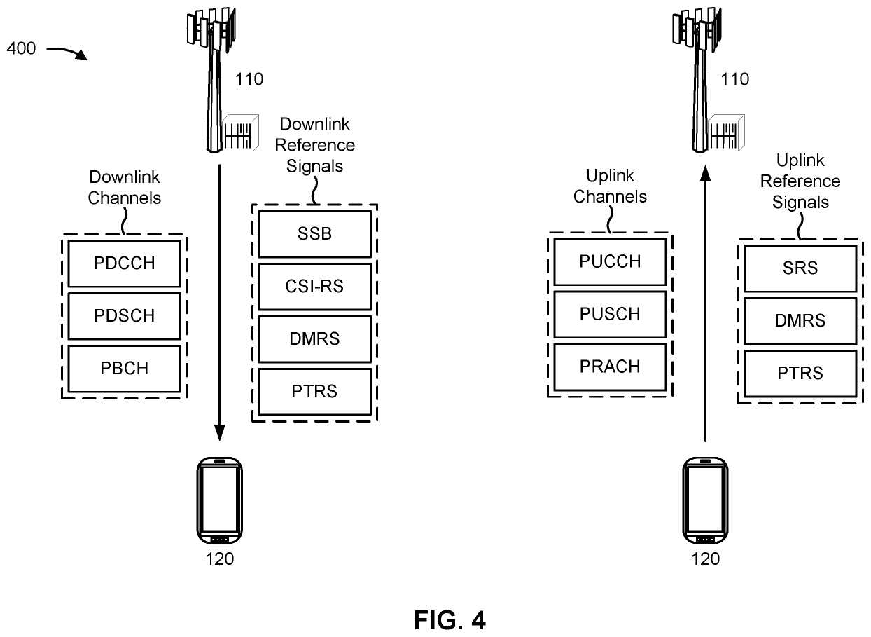

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

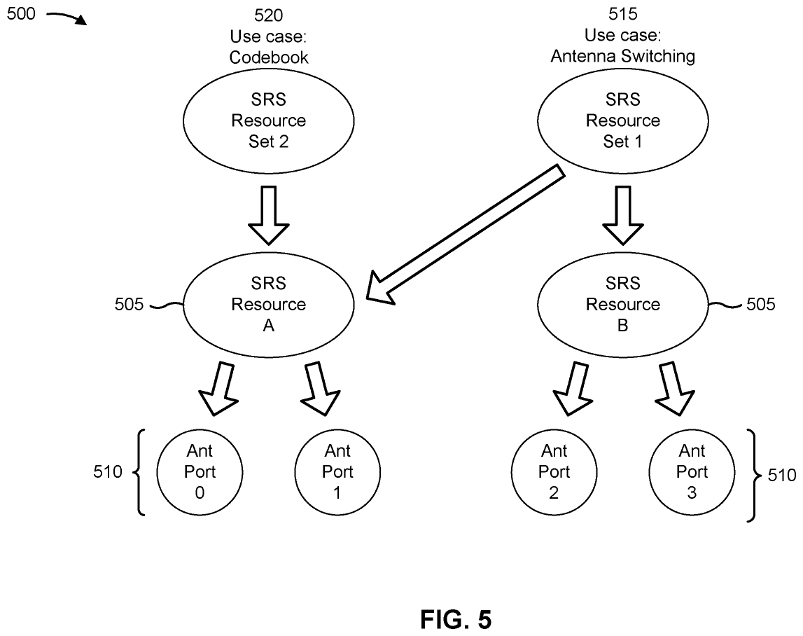

FIG. 5 is a diagram illustrating an example 500 of SRS resource sets, in accordance with the present disclosure.

A base station 110 may configure a UE 120 with one or more SRS resource sets to allocate resources for SRS transmissions by the UE 120. For example, a configuration for SRS resource sets may be indicated in an RRC message (e.g., an RRC configuration message or an RRC reconfiguration message). As shown by reference number 505, an SRS resource set may include one or more resources (e.g., shown as SRS resources), which may include time resources and/or frequency resources (e.g., a slot, a symbol, a resource block, and/or a periodicity for the time resources).

As shown by reference number 510, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case or usage (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the base station 110 indicating an uplink precoder to be used by the UE 120). For example, when the UE 120 is configured to select an uplink precoder, the base station 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the base station 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a MAC control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 5, in some aspects, different SRS resource sets indicated to the UE 120 (e.g., having different use cases) may overlap (e.g., in time and/or in frequency, such as in the same slot). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 520, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

The configuration of one or more SRS resource sets may include a configuration of a comb spacing (K_{TC}), a comb offset (k̅_{TC}), and a cyclic shift parameter (n_{SRS}^{cs}) per SRS resource. The comb spacing (K_{TC}) is a spacing between resource elements (REs) in an OFDM symbol. For example, the comb spacing (K_{TC}) may be configured as 2, 4, or 8 per SRS resource. The comb offset (k̅_{TC}) indicates an offset to a starting RE in an OFDM symbol. For example, the comb offset (k̅_{TC}) may be configured as 0, 1, . . . , K_{TC}−1 per SRS resource. The cyclic shift parameter (n_{SRS}^{cs}) determines a cyclic shift of the SRS (or the cyclic shift of the first SRS port in the case in which the SRS resource is configured with more than one antenna port). For example, the cyclic shift parameter (n_{SRS}^{cs}) may indicate a number of cyclic shifts and may be configured as 0, 1, . . . , n_{SRS}^{cs,max}−1 per SRS resource, where n_{SRS}^{cs,max} is a maximum number of cyclic shifts. The maximum number of cyclic shifts (n_{SRS}^{cs,max}) may depend on the comb spacing (K_{TC}). For example, the maximum number of cyclic shifts (n_{SRS}^{cs,max}) for each comb spacing (K_{TC}) value may be specified in a wireless communication standard (e.g., a 3GPP standard). In some examples, n_{SRS}^{cs,max} may be 8 for K_{TC} of 2, n_{SRS}^{cs,max} may be 12 for K_{TC} of 4, and n_{SRS}^{cs,max} may be 6 for K_{TC} of 8.

The cyclic shift may be applied to a base sequence for the SRS as e^{jα}^{ᵢ}ⁿr̅_{u,v}(n), where

$${α}_{i} = 2 π \frac{{n}_{SRS}^{cs , i}}{{n}_{SRS}^{cs , max}} , {n}_{SRS}^{c s , i} = ( {n}_{SRS}^{c s} + \frac{{n}_{SRS}^{cs , max} ( {p}_{i} - 1000 )}{{N}_{ap}^{SRS}} ) mod {n}_{SRS}^{cs , max} ,$$

pᵢ is an antenna port number (starting from 1000), Nₐₚ^{SRS} is a number of antenna ports configured for the SRS resource, and r̅_{u,v}(n) is the base sequence of length n. Different cyclic shifts of the same base sequence are orthogonal, as long as the cyclic shift spacing does not become too small relative to the delay spread of the channel. Different cyclic shifts may be used for different SRS ports (e.g., in a case in which an SRS resource is configured with more than one antenna port) or for different SRS resources (e.g., different SRS resources from the same UE or from different UEs). For example, different cyclic shifts may be used to ensure orthogonality among SRS transmissions from all antenna ports configured for a given SRS resource, or among SRS transmissions associated with different SRS resources (from the same UE or from different UEs).

In NR, multiple base sequences r̅_{u,v}(n) of flexible length are available for SRS transmissions. In some examples, multiple sequences for a given length may be organized in 30 different sequence groups, where u∈{0, 1, . . . , 29} indexes a sequence group and v∈{0, 1} indexes sequences within a group. The number of sequences per group may depend on the sequence length. For example, for sequences with a length greater than or equal to 72 bits, there may be two sequences per group (e.g., v=0 and v=1), and for sequences with a length less than 72 bits, there may be only one sequence per group and v=0. Different base sequences (e.g., different (u, v)) may not be completely orthogonal, but may have low cross-correlation. As a result, interference, at the receiver (e.g., the base station), between SRSs transmitted using different base sequences may be low.

The configuration of one or more SRS resource sets may include a configuration of an SRS sequence identity n_{ID}^{SRS} per SRS resource. The configuration may also indicate, per SRS resource, whether group hopping, sequence hopping, or neither is configured. When neither group hopping nor sequence hopping is configured for an SRS resource, the base sequence may be a base sequence with u=n_{ID}^{SRS} mod 30 and v=0. In this case, the base sequence may be fixed across all OFDM symbols in all slots for the SRS transmission in the SRS resource. In some aspects, when neither group hopping nor sequence hopping is configured, the network may perform interference planning by assigning n_{ID}^{SRS} to different SRS resources of different UEs across a same cell or different cells to avoid or reduce interference between the SRSs transmitted by the different UEs.

“Group hopping” refers to randomly or pseudo-randomly selecting the sequence group (e.g., randomly or pseudo-randomly selecting the group index u) for the base sequence for an SRS transmission in an SRS resource. In some examples, when group hopping is configured for an SRS resource, the sequence index may be fixed at v=0, and the group index u may be pseudo-randomly selected in every OFDM symbol of the SRS resource and in every slot occupied by the SRS resource. A pseudo-random sequence c(i) governing the group hopping may be initialized as cᵢₙᵢₜ=n_{ID}^{SRS} at the beginning of each radio frame. In this way, interference randomization may be accomplished by hopping across the 30 groups of base sequences.

“Sequence hopping” refers to randomly or pseudo-randomly selecting a base sequence from multiple base sequences in a sequence group (randomly or pseudo-randomly selecting the sequence index v) for an SRS transmission in an SRS resource. In some examples, when sequence hopping is configured for an SRS resource, the group index may be fixed at u=n_{ID}^{SRS} mod 30, and the sequence index v may be pseudo-randomly selected between 0 and 1 in every OFDM symbol of the SRS resource and in every slot occupied by the SRS resource. The pseudo-random sequence c(i) governing the group hopping may be initialized as cᵢₙᵢₜ=n_{ID}^{SRS} at the beginning of each radio frame. In this way, interference randomization, by hopping across 2 sequences, may be combined with interference planning across sequence groups.

As shown in FIG. 5, SRS resources may be configured within an SRS resource set that includes one or more SRS resources. This configuration mechanism allows for multiple SRS resources to be activated (e.g., for semi-persistent SRS resources) or triggered (e.g., for aperiodic SRS resources) simultaneously. An SRS resource set may be configured as aperiodic, semi-persistent, or periodic. A base station may transmit DCI to a UE to trigger aperiodic SRS resource set for the UE. For example, an aperiodic SRS resource set may be triggered with downlink DCI (e.g., DCI format 1_1 or DCI format 1_2), uplink DCI (e.g., DCI format 0_1 or DCI format 0_2), or group-common DCI (e.g., DCI format 23). The DCI may include an SRS request field, and the SRS request field may include a codepoint that indicates one or more SRS resource sets. For example, a mapping between SRS resource sets and the SRS request codepoints (e.g., 01, 10, and 11) may be indicated in RRC configuration information (e.g., aperiodicSRS-ResourceTrigger or aperiodicSRS-ResourceTriggerList). A base station may transmit a MAC-CE to a UE that activates or deactivates a semi-persistent SRS resource set for the UE.

As indicated above, FIG. 5 is provided as an example. Other examples may differ from what is described with regard to FIG. 5.

In some examples, such as for coherence joint transmission (CJT) across multiple TRPs, multiple TRPs may receive SRS transmissions from a UE. For a large number of UEs, multiple UEs may be configured to transmit SRSs on the same OFDM symbols, on the same REs, and with the same cyclic shift. In this case, interference mitigation or randomization relies on using the UE's different SRS base sequences for the SRS transmissions. However, in some examples, when neither group hopping, nor sequence hopping, is configured for an SRS resource, the sequence index v is fixed at v=0, such that only up to 30 base sequences can be assigned to different SRS resources (e.g., configured for different UEs). This may be insufficient for interference mitigation, particularly in cases in which multiple UEs are communicating with multiple TRPs. In some examples, either group hopping (across 30 groups) or sequence hopping (across 2 sequences within a group) may be configured for interference randomization. However, a UE cannot currently be configured to hop across all 60 sequences, and group hopping or sequence hopping may not be provide sufficient interference randomization, particularly in cases in which multiple UEs are communicating with multiple TRPs. As a result, cross-SRS interference may reduce the quality of SRS measurements performed by the TRPs.

Some techniques and apparatuses described herein enable a UE to receive, from a network entity, a configuration of an SRS resource. In some aspects, the configuration may indicate a sequence index value for a base sequence for the SRS resource. In some aspects, the configuration may indicate that the SRS resource is configured with group hopping and sequence hopping. The UE may transmit an SRS in the SRS resource in accordance with the configuration of the SRS resource. The configuration, by indicating the sequence index value for the SRS resource instead of fixing the sequence index value at 0, can increase the number of base sequences that can be assigned to different SRS resources for interference planning. Additionally, or alternatively, the SRS resource may be configured with both group hopping and sequence hopping, which increases the number of sequences used for interference randomization. As a result, interference mitigation, via interference planning and/or interference randomization, is enhanced, which may reduce cross-interference SRS, particularly in cases in which multiple UEs communicate with multiple TRPs.

In some examples, such as when multiple TRPs receive SRS transmissions from multiple UEs, the network may attempt to configure SRS parameters to ensure orthogonality and/or to minimize or randomize interference between SRS transmissions. In this case, the set of UEs that transmit SRSs on the same resource REs and OFDM symbols may depend on dynamic factors, such as scheduling decisions and downlink traffic. However, most SRS parameters (e.g., comb spacing, comb offset, cyclic shift, SRS sequence identity, and/or group or sequence hopping) are semi-statically configured via RRC configuration. As a result, the configured SRS parameters may not reflect current dynamic factors, such as scheduling decisions and downlink traffic. This may reduce the effectiveness of the configured SRS parameters in ensuring orthogonality and/or interference mitigation between SRS transmissions.

Some techniques and apparatuses described herein enable, a network entity to transmit, and a UE to receive, a configuration of parameters for an SRS resource of an SRS resource set. The network entity may transmit, and the UE may receive, a dynamic indication an updated values for one or more of the parameters for the SRS resource. For example, the dynamic indication may include an updated value for at least one of a comb spacing parameter, a comb offset parameter, a cyclic shift parameter, an SRS sequence identity, or a parameter indicating whether group hopping or sequence hopping is enabled for the SRS resource. The UE may transmit the SRS in the SRS resource in accordance with the updated values for the one or more of the parameters for the SRS resource. As a result, the SRS parameters that affect orthogonality and/or interference mitigation (e.g., comb spacing, comb offset, cyclic shift, SRS sequence identity, and/or group or sequence hopping) may be dynamically updated to reflect current scheduling decisions and/or downlink traffic, which increases the effectiveness of SRS parameters in ensuring orthogonality and/or interference mitigation between SRS transmissions.

FIG. 6 is a diagram illustrating an example 600 associated with enhanced interference mitigation for SRS, in accordance with the present disclosure. As shown in FIG. 6, example 600 includes communication between a network entity 605 (e.g., base station 110, CU 310, DU 330, RU 340, or a combination thereof) and a UE 120. In some aspects, the network entity 605 and the UE 120 may be included in a wireless network, such as wireless network 100. The network entity 605 and the UE 120 may communicate via a wireless access link, which may include an uplink and a downlink.

As shown in FIG. 6, and by reference number 610, the network entity 605 may transmit, and the UE 120 may receive, a configuration of an SRS resource. In some aspects, the configuration of the SRS resource may include an indication of a sequence index value v for a base sequence for the SRS resource, an indication that the SRS resource is configured with group hopping and frequency hopping, or a combination thereof. The SRS resource may be included in an SRS resources, and the configuration of the SRS resource may be included in configuration information for the SRS resource set. In some aspects, the configuration information may include configuration information for multiple SRS resource sets, each including one or more SRS resources. The configuration information may be transmitted, from the network entity 605 to the UE 120, in an RRC message. In some aspects, the configuration information may include a configuration of a set of SRS parameters for each SRS resource in an SRS resource set. For example, the configuration of an SRS resource may include a configuration of a comb spacing parameter K_{TC}, comb offset parameter k̅_{TC}, a cyclic shift parameter n_{SRS}^{cs}, and/or an SRS sequence identity n_{ID}^{SRS} for the SRS resource. In some aspects, the SRS sequence identity n_{ID}^{SRS} may indicate the sequence group index value u that identifies the sequence group for the base sequence for the SRS resource (e.g., when group hopping is not configured for the SRS resource) or may be used to initiate a pseudo-random sequence for group hopping (e.g., when group hopping is configured for the SRS resource).

In some aspects, the configuration for an SRS resource may indicate a sequence index value v for the base sequence for the SRS resource. For example, the configuration for an SRS resource with a length that is equal to or larger than a length threshold (e.g., 72 bits) may indicate the sequence index value v for the base sequence of the SRS resource. In some aspects, the configuration information for one or more SRS resources sets may indicate a respective sequence index value v per SRS resource, for all SRS resources with an SRS sequence length that is equal to or larger than the length threshold (e.g., 72 bits). The sequence index value v may identify a sequence, among multiple sequences in a sequence group. In some aspects, the sequence index value v for an SRS resource may be either 0 (e.g., corresponding to a first sequence in a group) or 1 (e.g., corresponding to second sequence in a group). In some aspects, the configuration of the SRS resource sequence may include an explicit indication of the index value v configured for the SRS resource. For example, the configuration of the SRS resource may indicate a sequence index value of v=0 or v=1 for the SRS resource. In some aspects, one or more other parameters in the configuration of the SRS resource may provide an implicit indication of the sequence index value v for the SRS resource. For example, the SRS sequence identity n_{ID}^{SRS} may provide an indication of the sequence index value v as v=└n_{ID}^{SRS}/30┘ mod 2. In this case, the UE 120 may derive the sequence index value v from the SRS sequence identity n_{ID}^{SRS}.

In some aspects, the configuration of the SRS resource may indicate whether group hopping, sequence hopping, neither, or both is configured for the SRS resource. In some aspects, the configuration may indicate the sequence index value v for an SRS resource that is configured with neither group hopping, nor sequence hopping. In this case, both the group index value u and the sequence index v may be fixed for the SRS resource across all OFDM symbols. In this way, both the group index value u and the sequence index value v for the SRS sequence are configurable (e.g., via the configuration information) by the network entity 605 or another network device. For example, the network entity 605 or another network device may configure respective group index values u and sequence index values v for SRS resources configured for the UE 120 and/or one or more other UEs to perform interference planning in order to avoid or reduce interference between SRS transmissions in the SRS resources. In a case in which there are 30 sequence groups (e.g., u∈{0, 1, . . . , 29}) and two sequences per group (e.g., v∈{0, 1}), the network entity 605 or another network device may perform interference planning by selecting base sequences for SRS resources from among 60 different base sequences that have low cross-correlation properties.

In some aspects, the configuration of an SRS resource may indicate the sequence index value v for an SRS resource, and only group hopping may be configured for the SRS resource. In this case, the sequence index value v may be fixed across all symbols and configurable for the SRS resource by the network entity 605 or another network device. In this way, interference randomization by performing hopping across values of u for SRS transmissions in the SRS resource may be combined with interference planning by configuring the values of v for one or more SRS resources. In some aspects, the configuration of an SRS resource may indicate the sequence index value v for an SRS resource, and sequence hopping (e.g., within a group) may be configured for the SRS resource.

In some aspects, the configuration of an SRS resource may indicate that the SRS resource is configured with both group hopping and sequence hopping. For example, a configuration of an SRS resource with a length that is equal to or larger than a length threshold (e.g., 72 bits) may indicated that both group hopping and sequence hopping is configured for the SRS resource. In this case, the UE 120 may be configured to perform hopping across the values of u and the values of v for SRS transmissions in the SRS resource in different symbols in which the SRS resource is configured based at least in part on a pseudo-random sequence that is a function of a slot number and an OFDM symbol number associated with each SRS transmission. In this way, in a case in which there are 30 sequence groups (e.g., u∈{0, 1, . . . , 29}) and two sequences per group (e.g., v∈{0, 1}), the UE 120 may be configured to hop across 60 base sequence for improved interference randomization, as compared to only performing group hopping or sequence hopping.

As further shown in FIG. 6, and by reference number 615, the UE 120 may transmit the SRS in the SRS resource in accordance with the configuration of the SRS resource. The network entity 605 may receive the SRS transmitted by the UE 120. In some aspects, the UE 120 may transmit, and the network entity 605 may receive, multiple SRS transmissions in different OFDM symbols configured for the SRS resource in one or more slots.

In some aspects, the configuration of the SRS resource may indicate the sequence index value v for the SRS resource, and the SRS resource may be configured with neither group hopping, nor sequence hopping. In this case, the configuration may also indicate the group index value u, and the UE 120 may transmit the SRS using a base sequence associated with the group index value u and the sequence index value v in all of the OFDM symbols in which the SRS resource is configured. For example, the SRS sequence identity n_{ID}^{SRS} may provide an indication of the group index value u as u=n_{ID}^{SRS} mod 30.

In some aspects, the configuration of the SRS resource may indicate the sequence index value v for the SRS resource, and group hopping may be configured for SRS resource (e.g., the SRS resource may be configured with group hopping and not sequence hopping). In this case, for each OFDM symbol in which the SRS resource is configured, the UE 120 may select a group index value u using group hopping over the set of sequence groups based at least in part on a pseudo-random sequence c(i) and based at least in part on an OFDM symbol number and a slot number. For example, for each OFDM symbol in which the SRS resource is configured, the UE 120 may determine the group index value u as u=(f_{gh}(n_{s,f}^{μ}, l′)+n_{ID}^{SRS})mod 30, where f_{gh}(n_{s,f}^{μ}, l′)=(Σₘ₌₀⁷c(8(n_{s,f}^{μ}N_{symb}^{slot})+l₀+l′)+m·2^{m})mod 30, n_{s,f}^{μ} is a slot number with a frame, and l₀+l′ is the symbol number within the slot. In each OFDM symbol in which the SRS resource is configured, the UE 120 may transmit the SRS using a respective base sequence associated with the sequence index value v indicated by the configuration of the SRS resource and the group index value u selected for that OFDM sequence using group hopping.

In some aspects, the configuration of the SRS resource may indicate the sequence index value v for the SRS resource, and sequence hopping (e.g., within a group) may be configured for SRS resource (e.g., the SRS resource may be configured with sequence hopping and not group hopping). In some aspects, in a case in which the SRS resource indicates the sequence index value v for the SRS resource and sequence hopping is configured for the SRS resource, the UE 120 may ignore the sequence index value v indicated in the configuration when performing sequence hopping. In this case, for each OFDM symbol in which the SRS resource is configured, the UE 120 may select the sequence index using a pseudo-random sequence c(i) based at least in part on the OFDM symbol number and the slot number as v=c(n_{s,f}^{μ}N_{symb}^{slot}+l₀+l′). In each OFDM symbol in which the SRS resource is configured, the UE 120 may transmit the SRS using a base sequence associated with group index value u indicated by the configuration of the SRS resource and the group index value v selected for that OFDM.

In some aspects, in a case in which the SRS resource indicates the sequence index value v for the SRS resource and sequence hopping is configured for the SRS resource, the UE 120 may select the sequence index value v for each OFDM symbol in which the SRS resource is configured using sequence hopping based at least in part on the sequence index value indicated by the configuration. For example, the indicated sequence index value may be used as an initialization point for pseudo-random sequence c(i) that governs the sequence hopping. In some aspects, in a case in which the configuration of the SRS resource includes an explicit indication of a sequence index value v₀, the UE 120 may determine the sequence index value v for an OFDM symbol as v=(c(n_{s,f}^{μ}N_{symb}^{slot}+l₀+l′)+v₀)mod 2. In some aspects, in a case in which the SRS sequence identity n_{ID}^{SRS} provides an implicit indication of the sequence index value, the UE 120 may determine the sequence index value v for an OFDM symbol as v (c(n_{s,f}^{μ}N_{symb}^{slot}+l₀+l′)+└n_{ID}^{SRS}/30┘)mod 2. In some aspects, the UE 120 may determine the sequence index value as v=(fₛₕ(n_{s,f}^{μ}, l′)+x)mod 2, where x is the value of v when sequence hopping is not configured (e.g., x=v₀ or x=└n_{ID}^{SRS}/30┘), and fₛₕ(.) is the sequence hopping formula as a function of the slot number and the symbol number. In this case, fₛₕ(n_{s,f}^{μ}, l′)=c(n_{s,f}^{μ}N_{symb}^{slot}+l₀+l′) when sequence hopping is configured, and fₛₕ(n_{s,f}^{μ}, l′)=0 when sequence hopping is not configured. In each OFDM symbol in which the SRS resource is configured, the UE 120 may transmit the SRS using a base sequence associated with group index value u indicated by the configuration of the SRS resource and the group index value v selected for that OFDM using sequence hopping (e.g., based at least in part on the indicated sequence index value).

In some aspects, the configuration of the SRS resource may indicate that the SRS resource is configured with both group hopping and sequence hopping. In some aspects, in a case in which the SRS resource is configured with both group hopping and sequence hopping, the UE 120 may separately select, for each OFDM symbol in which the SRS resource is configured, a group index value u using group hopping in accordance with a pseudo-random sequence c(i) based at least in part on the symbol number and the slot number and a sequence index value v using sequence hopping in accordance the pseudo-random sequence c(i) based at least in part on the symbol number and the slot number. For example, the UE 120 may determine the group index value u for an OFDM symbol as =(f_{gh}(n_{s,f}^{μ}, l′)+n_{ID}^{SRS})mod 30, where f_{gh}(n_{s,f}^{μ}, l′)=(Σₘ₌₀₇c(8(n_{s,f}^{μ}N_{symb}^{slot})+l₀+l′)+m·2^{m})mod 30. The UE 120 may determine the sequence index value v as v=c(n_{s,f}^{μ}N_{symb}^{slot}+l₀+l′) when the length of the SRS sequence is equal to or longer than the length threshold (e.g., 72 bits) (or v=0 when the length of the SRS sequence is not equal to or longer than the length threshold). Alternatively, in a case in which the configuration indicates a sequence index value for the SRS resource and both group hopping and sequence hopping are configured for the SRS resource, the UE 120 may determine the sequence index value v using sequence hopping based at least in part on the indicated sequence index value, as described above. The UE 120 may transmit the SRS, in each OFDM symbol in which the SRS resource is configured, using a respective base sequence associated with the selected group index value u and the selected sequence index value v for the OFDM symbol.

In some aspects, in a case in which the SRS resource is configured with both group hopping and sequence hopping, for each OFDM symbol in which the SRS resource is configured, the UE 120 may generate a number (z) based at least in part on a pseudo-random sequence c(i) as a function of the slot number and the OFDM symbol number. The UE 120 may then determine the group index value u and the sequence index value v for the OFDM symbol based at least in part on the number z generated for the OFDM symbol. For example, z may be a number (e.g., 0≤z≤59) generated as z=(Σₘ₌₀^{M-1}c(M·(n_{s,f}^{μ}N_{symb}^{slot}+l₀+l′)+m)·2^{m}) mod 60, where M is a fixed number. In this case, the UE 120 may determine the group index value u as u=z mod 30, and the UE 120 may determine the sequence index value v as v=└z/30┘ or v=z mod 2. The UE 120 may transmit the SRS, in each OFDM symbol in which the SRS resource is configured, using a respective base sequence associated with the selected group index value u and the selected sequence index value v for the OFDM symbol.

In some aspects, the pseudo-random sequence c(i) that governs the group hopping and the sequence hopping may be initialized by (e.g., by cᵢₙᵢₜ=n_{ID}^{SRS}) every N radio frames (e.g., at the beginning of each group of N radio frames instead of at the beginning of every radio frame), where N>1. In this case, the value of N may fixed (e.g., specified in a wireless communication standard), RRC-configured (e.g., indicated in the configuration of the SRS resource or SRS resource set), or determined as a function of the subcarrier spacing. Depending on the subcarrier spacing, periodicity of the SRS resource, and number of OFDM symbols configured for the SRS resource, the number of SRS symbols within a radio frame may be well below 60. By re-initializing the pseudo-random sequence c(i) every N>1 frames, the group and sequence hopping can hop across more of the 60 total base sequences available, as compared to re-initializing the pseudo-random sequence c(i) every frame. In some aspects, a system frame number (SFN) may be used to determine when to rest (e.g., initialize) the pseudo-random sequence (e.g., when SFN mod N=0). In some aspects, initializing the pseudo-random sequence every N frames may be used when both group hopping and frequency hopping is configured for an SRS resource, when only group hopping is configured for an SRS resource, and/or when only sequence hopping is configured for an SRS resource.

As indicated above, FIG. 6 is provided as an example. Other examples may differ from what is described with respect to FIG. 6.

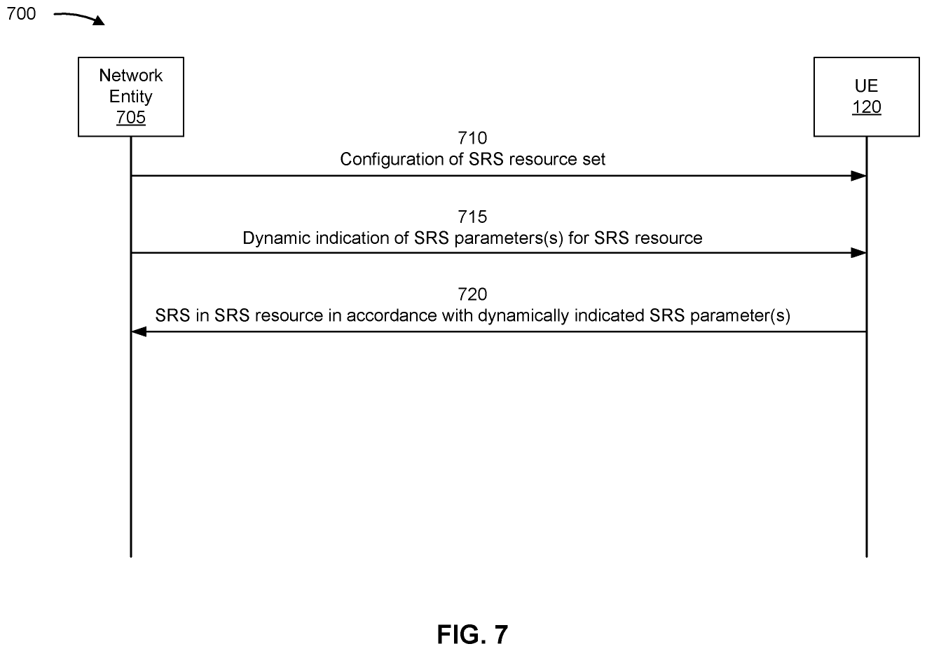

FIG. 7 is a diagram illustrating an example 700 associated with enhanced interference mitigation for SRS, in accordance with the present disclosure. As shown in FIG. 7, example 700 includes communication between a network entity 705 (e.g., base station 110, CU 310, DU 330, RU 340, or a combination thereof) and a UE 120. In some aspects, the network entity 705 and the UE 120 may be included in a wireless network, such as wireless network 100. The network entity 705 and the UE 120 may communicate via a wireless access link, which may include an uplink and a downlink.

As shown in FIG. 7, and by reference number 710, the network entity 705 may transmit, and the UE 120 may receive, a configuration of an SRS resource set. The SRS resource set may be included in one or more SRS resources, and the configuration of the SRS resource set may include a configuration of each SRS resource included in the SRS resource set. In some aspects, the configuration may include configuration information for multiple SRS resource sets, each including one or more SRS resources. The configuration may be transmitted, from the network entity 705 to the UE 120, in an RRC message. In some aspects, the configuration may include a configuration of a set of SRS parameters for each SRS resource in the SRS resource set. For example, the configuration of an SRS resource may include a configuration of a comb spacing parameter K_{TC}, comb offset parameter k̅_{TC}, a cyclic shift parameter n's, an SRS sequence identity n_{ID}^{SRS} for the SRS resource (e.g., which indicates a group index value u) or an indication of the group index parameter u, and/or a parameter that indicates whether at least one of group hopping or sequence hopping is configured for the SRS resource. In some aspects, the parameter that indicates whether at least one of group hopping or sequence hopping is configured for the SRS resource may indicate that group hopping is enabled for the SRS resource, sequence hopping is enabled for the SRS resource, neither group hopping, nor sequence hopping, is enabled for the SRS resource, or both group hopping and sequence hopping is enabled for the SRS resource.

As further shown in FIG. 7, and by reference number 715, the network entity 705 may transmit, and the UE 120 may receive, a dynamic indication of one or more SRS parameters for an SRS resource. In some aspects, the dynamic indication may indicate updated values for one or more of the SRS parameters configured for an SRS resource. In some aspects, the dynamic indication may be included in DCI or a MAC-CE transmitted to the UE 120 by the network entity 705.

In some aspects, values for multiple SRS parameters can be jointly coded in a bit field of the DCI or MAC-CE. For example, the values for SRS parameters may be jointly coded due, at least in part, to value ranges of some SRS parameters not being completely independent. In the case in which multiple SRS parameters are jointly coded in a bit field of the DCI or MAC-CE, value of the bit field in the DCI or MAC-CE may indicate an index value that maps to a profile with a set of values (e.g., updated values) for the multiple SRS parameters. In this case, a set of profiles and corresponding index values may be configured (e.g., in RRC configuration information) for the UE 120. For example, the network (e.g., the network entity 705 and/or another network device) may configure a number of profiles to control a tradeoff between flexibility and signaling overhead.

In some aspects, values for the comb spacing parameter K_{TC} and the comb offset parameter k̅_{TC} may be jointly coded in a one bit field of the DCI or MAC-CE. For example, K_{TC} and k̅_{TC} may be jointly coded in a bit field with 4 bits, as there may be only 14 possible combinations of values (e.g., 2+4+8). In some aspects, the comb spacing parameter K_{TC}, the comb offset parameter k̅_{TC}, and the cyclic shift parameter n_{SRS}^{cs} may be jointly encoded in one bit field of the DCI or MAC-CE. For example, K_{TC}, k̅_{TC}, and n_{SRS}^{cs} may be jointly encoded in one bit field with 7 bits, as there may be 112 possible combinations of values (e.g., 2*8+4*12+8*6). In some aspects, the group index value u, the parameter that indicates whether at least one of group hopping or sequence hopping is enabled may be jointly encoded in one bit field of the DCI or MAC-CE. For example, the group index value u, the parameter that indicates group or sequence hopping may be jointly encoded in one bit field with 5 bits, as there may be 61 possible combinations of values (e.g., 30+30+1). In this case, when neither group hopping, nor sequence hopping, is enabled, u can be dynamically indicated as 0, . . . , 29, when sequence hopping is enabled, u can be dynamically indicated as 0, . . . , 29, and when group hopping is enabled, u does not need to be dynamically indicated.

In some the dynamic indication of the updated values for the one or more SRS parameters can be for a particular SRS resource, for an SRS resource set (e.g., applied to all SRS resources within an SRS resource set), or for multiple SRS resource sets (e.g., applied to all SRS resources within the SRS resource sets). For example, a case in which the dynamic indication is for multiple SRS resource sets may provide a benefit of allowing SRS parameters for SRS resources in multiple SRS resource sets to be dynamically updated with a small signaling overhead. In this case, the criteria for selecting the multiple SRS resource sets for which the SRS parameters are updated may be based at least in part on the usage configured for each SRS resource set (e.g., all SRS resource sets with a usage set to “antenna switching” or SRS resource sets associated with another usage).

In some aspects, the dynamic indication may be included in DCI. In some aspects, the dynamic indication may be included in the same DCI that triggers one or more SRS resource sets (e.g., one or more aperiodic SRS resource sets). In this case, the updated values dynamically indicated in the triggering DCI may be applied to all SRS resources within the SRS resource sets triggered by the DCI. In some aspects, the SRS field of the DCI (e.g., the triggering DCI) may be used to indicate a set of values for one or more SRS parameters. In this case, each value of the SRS request field may be associated with a respective set of values for one or more SRS parameters, and the association between different values of the SRS request field and respective sets of values for the SRS parameters may be indicated via RRC configuration. In some aspects, in a case in which uplink DCI (e.g., DCI format 0_1 or 0_2) without uplink data (e.g., with an uplink scheduling indicator field equal to 0) (and without a CSI request) triggers one or more aperiodic SRS resource sets, the dynamic indication of the values for the one or more SRS parameters may be included in one or more unused bit fields of the uplink DCI, such as a time domain resource allocation (TDRA) field, a frequency domain resource allocation (FDRA) field, an MCS field, a new data indicator (NDI) field, a hybrid automatic repeat request (HARQ) identifier (ID) field, and/or redundancy version (RV) field, among other examples. In some aspects, downlink DCI (e.g., DCI format 1_1 or 1_2) may be used to trigger one or more aperiodic SRS resource sets without scheduling a PDSCH communication for the UE 120. In this case, some of the fields (e.g., FDRA) may be used to determine that PDSCH is not scheduled, and one or more unused bit fields of the downlink DCI, such as the TDRA field, the MCS field, the NDI field, the HARQ ID field, the RV field, and/or the antenna port(s) field, among other examples, may be used for the dynamic indication of the values for the one or more SRS parameters.

In some aspects, the dynamic indication may be included in a new DCI format, which may or may not trigger one or more SRS resource sets. In this case, the DCI may include an indication of one or multiple SRS resource IDs to which the indicated set of values for one or more SRS parameters applies, or the DCI may include an indication a resource set ID (or multiple resource set IDs) to which the indicated set of values for one or more SRS parameters applies. In this case, the DCI may be used to dynamically indicate updated values for periodic, semi-persistent, and/or aperiodic SRS resources or SRS resource sets.

In some aspects, the dynamic indication may be included in a MAC-CE. In some aspects, the dynamic indication may be included in the same MAC-CE that activates an SRS resource set (e.g., a semi-persistent SRS resource set). In this case, the UE 120 may apply the indication to all SRS resources included in the activated SRS resource set. In some aspects, the dynamic indication may be included in a new MAC-CE, which may or may not activate an SRS resource set. In this case, the MAC-CE may include an indication of one or multiple SRS resource IDs to which the indicated set of values for one or more SRS parameters applies, or the MAC-CE may include an indication a resource set ID (or multiple resource set IDs) to which the indicated set of values for one or more SRS parameters applies. In this case, the MAC-CE may be used to dynamically indicate updated values for periodic, semi-persistent, and/or aperiodic SRS resources or SRS resource sets.

As further shown in FIG. 7, and by reference number 720, the UE 120 may transmit an SRS in the SRS resource in accordance with the one or more dynamically indicated SRS parameters indicated in the dynamic indication. The network entity 705 may receive the SRS transmitted by the UE 120. In some aspects, the UE 120 may transmit, and the network entity 705 may receive, multiple SRS transmissions in different OFDM symbols configured for the SRS resource in one or more slots. In some aspects, in connection with receiving the dynamic indication of updated values for one or more SRS parameters that applied to one or more SRS resources, the UE 120, when transmitting an SRS in an SRS resource to which the dynamic indicate applies, may apply the updated values for the one or more parameters (e.g., instead of original values for the one or more parameters configured in the configuration).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with enhanced interference mitigation for SRS.

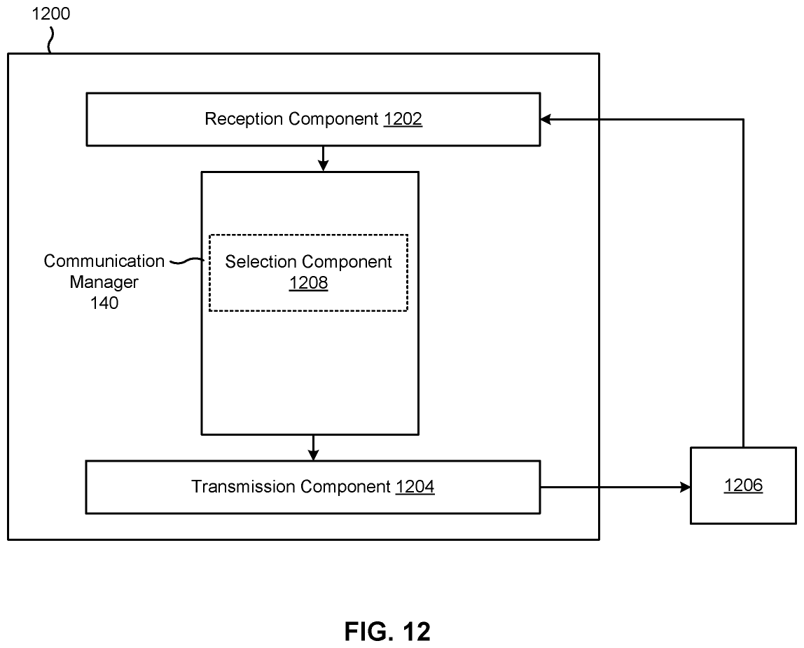

As shown in FIG. 8, in some aspects, process 800 may include receiving a configuration of an SRS resource, wherein the configuration indicates a sequence index value for a base sequence for the SRS resource or the configuration indicates that the SRS resource is configured with group hopping and sequence hopping (block 810). For example, the UE (e.g., using communication manager 140 and/or reception component 1202, depicted in FIG. 12) may receive a configuration of an SRS resource, wherein the configuration indicates a sequence index value for a base sequence for the SRS resource or the configuration indicates that the SRS resource is configured with group hopping and sequence hopping, as described above.

As further shown in FIG. 8, in some aspects, process 800 may include transmitting an SRS in the SRS resource in accordance with the configuration of the SRS resource (block 820). For example, the UE (e.g., using communication manager 140 and/or transmission component 1204, depicted in FIG. 12) may transmit an SRS in the SRS resource in accordance with the configuration of the SRS resource, as described above.

Process 800 may include additional aspects, such as any single aspect or any combination of aspects described below and/or in connection with one or more other processes described elsewhere herein.

In a first aspect, the configuration includes an indication of the sequence index value for the base sequence for the SRS resource.

In a second aspect, the configuration includes an indication of a sequence identity of the SRS resource, and the sequence identity of the SRS resource indicates the sequence index value for the base sequence for the SRS resource.

In a third aspect, the configuration of the SRS resource is included in a configuration of an SRS resource set including a plurality of SRS resources, and the configuration of the SRS resource set indicates a respective sequence index value for each SRS resource of the plurality of SRS resources.

In a fourth aspect, the configuration indicates the sequence index value and a group index value for the base sequence for the SRS resource, and transmitting the SRS in the SRS resource in accordance with the configuration of the SRS resource comprises transmitting the SRS using a base sequence associated with the group index value and the sequence index value in all of one or more symbols in which the SRS resource is configured.

In a fifth aspect, the configuration indicates the sequence index value for the base sequence for the SRS resource and the configuration indicates that group hopping is configured for the SRS resource, and transmitting the SRS in the SRS resource in accordance with the configuration of the SRS resource comprises transmitting the SRS, in each of one or more symbols in which the SRS resource is configured, using a respective base sequence associated with the sequence index value and a group index value selected using group hopping over a plurality of base sequence groups.

In a sixth aspect, the configuration indicates the sequence index value for the base sequence for the SRS resource and the configuration indicates that sequence hopping is configured for the SRS resource, and transmitting the SRS in the SRS resource in accordance with the configuration of the SRS resource comprises transmitting the SRS, in each of one or more symbols in which the SRS resource is configured, using a respective base sequence selected using sequence hopping based at least in part on the sequence index value indicated by the configuration.

In a seventh aspect, the configuration indicates that the SRS resource is configured with group hopping and sequence hopping, and transmitting the SRS in the SRS resource in accordance with the configuration of the SRS resource comprises transmitting the SRS, in each of one or more symbols in which the SRS resource is configured, using a respective base sequence associated with a group index value selected using group hopping in accordance with a pseudo-random sequence based at least in part on a slot number and a symbol number and a sequence index value selected using sequence hopping in accordance with the pseudo-random sequence based at least in part on the slot number and the symbol number.

In an eighth aspect, the pseudo-random sequence is initialized every N radio frames, and N is greater than 1.

In a ninth aspect, N is indicated in the configuration or N is based at least in part on a subcarrier spacing.

In a tenth aspect, the configuration indicates that the SRS resource is configured with group hopping and sequence hopping, and transmitting the SRS in the SRS resource in accordance with the configuration of the SRS resource comprises transmitting the SRS, in each of one or more symbols in which the SRS resource is configured, using a respective base sequence associated with a group index value and a sequence index value, wherein the group index value and the sequence index value are determined based at least in part on a number generated in accordance with a pseudo-random sequence based at least in part on a slot number and a symbol number.

In an eleventh aspect, the pseudo-random sequence is initialized every N radio frames, and N is greater than 1.

In a twelfth aspect, N is indicated in the configuration or N is based at least in part on a subcarrier spacing.

In a thirteenth aspect, the configuration indicates at least one of a comb spacing for the SRS resource, a comb offset for the SRS resource, a cyclic shift for the SRS resource, an SRS sequence identity for the SRS resource, a group index value for the base sequence for the SRS resource, or whether at least one of group hopping or sequence hopping is to be performed for the SRS resource.

In a fourteenth aspect, process 800 includes receiving an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource.

In a fifteenth aspect, transmitting the SRS in the SRS resource comprises transmitting the SRS in the SRS resource in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

In a sixteenth aspect, the indication is included in DCI or a MAC-CE.

In a seventeenth aspect, the indication is included in DCI that triggers one or more SRS resource sets.

In an eighteenth aspect, the indication is included in a MAC-CE that activates a semi-persistent SRS resource set that includes the SRS resource.

In a nineteenth aspect, two or more of the an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource are jointly coded into a bit field of the DCI or the MAC-CE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network entity 605, network entity 705, base station 110, CU 310, DU 330, RU 340, or a combination thereof) performs operations associated with enhanced interference mitigation for SRS.

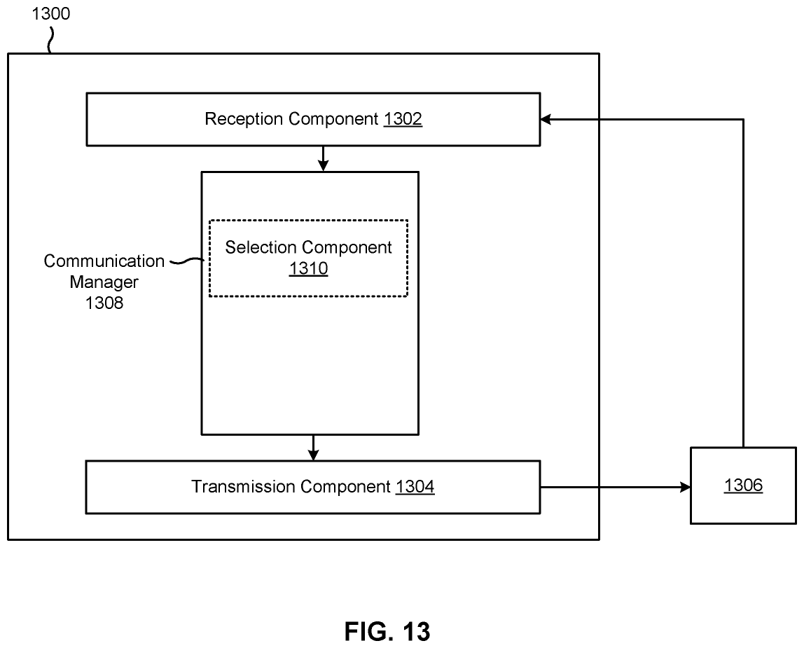

As shown in FIG. 9, in some aspects, process 900 may include transmitting a configuration of an SRS resource for a UE, wherein the configuration indicates a sequence index value for a base sequence for the SRS resource or the configuration indicates that the SRS resource is configured with group hopping and sequence hopping (block 910). For example, the network entity (e.g., using communication manager 1308 and/or transmission component 1304, depicted in FIG. 13) may transmit a configuration of an SRS resource for a UE, wherein the configuration indicates a sequence index value for a base sequence for the SRS resource or the configuration indicates that the SRS resource is configured with group hopping and sequence hopping, as described above.

As further shown in FIG. 9, in some aspects, process 900 may include receiving an SRS in the SRS resource in accordance with the configuration of the SRS resource (block 920). For example, the network entity (e.g., using communication manager 1308 and/or reception component 1302, depicted in FIG. 13) may receive an SRS in the SRS resource in accordance with the configuration of the SRS resource, as described above.

Process 900 may include additional aspects, such as any single aspect or any combination of aspects described below and/or in connection with one or more other processes described elsewhere herein.

In a first aspect, the configuration includes an indication of the sequence index value for the base sequence for the SRS resource.

In a second aspect, the configuration includes an indication of a sequence identity of the SRS resource, and the sequence identity of the SRS resource indicates the sequence index value for the base sequence for the SRS resource.

In a third aspect, the configuration of the SRS resource is included in a configuration of an SRS resource set including a plurality of SRS resources, and the configuration of the SRS resource set indicates a respective sequence index value for each SRS resource of the plurality of SRS resources.

In a fourth aspect, the configuration indicates the sequence index value and a group index value for the base sequence for the SRS resource, and the configuration indicates that neither group hopping, nor sequence hopping, is configured for the SRS resource.

In a fifth aspect, the configuration indicates the sequence index value for the base sequence for the SRS resource and the configuration indicates that group hopping is configured for the SRS resource.

In a sixth aspect, the configuration indicates the sequence index value for the base sequence for the SRS resource and the configuration indicates that sequence hopping is configured for the SRS resource.

In a seventh aspect, the configuration indicates that the SRS resource is configured with group hopping and sequence hopping.

In an eighth aspect, the configuration indicates a number of frames associated with initializing a pseudo-random sequence for the group hopping and the sequence hopping, and the number of frames is greater than 1.

In a ninth aspect, the configuration indicates at least one of a comb spacing for the SRS resource, a comb offset for the SRS resource, a cyclic shift for the SRS resource, an SRS sequence identity for the SRS resource, a group index value for the base sequence for the SRS resource, or whether at least one of group hopping or sequence hopping is to be performed for the SRS resource.

In a tenth aspect, process 900 includes transmitting an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource.

In an eleventh aspect, receiving the SRS in the SRS resource comprises receiving the SRS in the SRS resource in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

In a twelfth aspect, the indication is included in DCI or a MAC-CE.

In a thirteenth aspect, the indication is included in DCI that triggers one or more SRS resource sets.

In a fourteenth aspect, the indication is included in a MAC-CE that activates a semi-persistent SRS resource set that includes the SRS resource.

In a fifteenth aspect, two or more of the an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource are jointly coded into a bit field of the DCI or the MAC-CE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with enhanced interference mitigation for SRS.

As shown in FIG. 10, in some aspects, process 1000 may include receiving a configuration of parameters for an SRS resource of an SRS resource set (block 1010). For example, the UE (e.g., using communication manager 140 and/or reception component 1202, depicted in FIG. 12) may receive a configuration of parameters for an SRS resource of an SRS resource set, as described above.

As further shown in FIG. 10, in some aspects, process 1000 may include receiving a dynamic indication of an updated value for at least one of the parameters for the SRS resource (block 1020). For example, the UE (e.g., using communication manager 140 and/or reception component 1202, depicted in FIG. 12) may receive a dynamic indication of an updated value for at least one of the parameters for the SRS resource, as described above.

As further shown in FIG. 10, in some aspects, process 1000 may include transmitting an SRS in the SRS resource in accordance with the updated value for the at least one of the parameters for the SRS resource (block 1030). For example, the UE (e.g., using communication manager 140 and/or transmission component 1204, depicted in FIG. 12) may transmit an SRS in the SRS resource in accordance with the updated value for the at least one of the parameters for the SRS resource, as described above.

Process 1000 may include additional aspects, such as any single aspect or any combination of aspects described below and/or in connection with one or more other processes described elsewhere herein.

In a first aspect, the at least one of the parameters for the SRS resource includes at least one of a comb spacing parameter, a comb offset parameter, a cyclic shift parameter, an SRS sequence identity, a group index value, or a parameter that indicates whether at least one of group hopping or sequence hopping is to be performed for the SRS resource.

In a second aspect, the dynamic indication is included in DCI or a MAC-CE.

In a third aspect, the indication is included in DCI that triggers one or more SRS resource sets.

In a fourth aspect, the SRS resource set is a semi-persistent SRS resource set, and the dynamic indication is included in a MAC-CE that activates the SRS resource set.

In a fifth aspect, the dynamic indication includes an indication, in a bit field of the DCI or the MAC-CE, that is jointly coded to indicate updated values for two or more of the parameters for the SRS resource.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network entity 705, network entity 605, base station 110, CU 310, DU 330, RU 340, or a combination thereof) performs operations associated with enhanced interference mitigation for SRS.

As shown in FIG. 11, in some aspects, process 1100 may include transmitting a configuration of parameters for an SRS resource of an SRS resource set for a UE (block 1110). For example, the network entity (e.g., using communication manager 1308 and/or transmission component 1304, depicted in FIG. 13) may transmit a configuration of parameters for an SRS resource of an SRS resource set for a UE, as described above.

As further shown in FIG. 11, in some aspects, process 1100 may include transmitting a dynamic indication of an updated value for at least one of the parameters for the SRS resource (block 1120). For example, the network entity (e.g., using communication manager 1308 and/or transmission component 1304, depicted in FIG. 13) may transmit a dynamic indication of an updated value for at least one of the parameters for the SRS resource, as described above.

As further shown in FIG. 11, in some aspects, process 1100 may include receiving an SRS in the SRS resource in accordance with the updated value for the at least one of the parameters for the SRS resource (block 1130). For example, the network entity (e.g., using communication manager 1308 and/or reception component 1302, depicted in FIG. 13) may receive an SRS in the SRS resource in accordance with the updated value for the at least one of the parameters for the SRS resource, as described above.

Process 1100 may include additional aspects, such as any single aspect or any combination of aspects described below and/or in connection with one or more other processes described elsewhere herein.

In a first aspect, the at least one of the parameters for the SRS resource includes at least one of a comb spacing parameter, a comb offset parameter, a cyclic shift parameter, an SRS sequence identity, a group index value, or a parameter that indicates whether at least one of group hopping or sequence hopping is to be performed for the SRS resource.

In a second aspect, the dynamic indication is included in DCI or a MAC-CE.

In a third aspect, the indication is included in DCI that triggers one or more SRS resource sets.

In a fourth aspect, the SRS resource set is a semi-persistent SRS resource set, and the dynamic indication is included in a MAC-CE that activates the SRS resource set.

In a fifth aspect, the dynamic indication includes an indication, in a bit field of the DCI or the MAC-CE, that is jointly coded to indicate updated values for two or more of the parameters for the SRS resource.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a selection component 1208, among other examples.

In some aspects, the apparatus 1200 may be configured to perform one or more operations described herein in connection with FIGS. 6-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive a configuration of an SRS resource, wherein the configuration indicates a sequence index value for a base sequence for the SRS resource or the configuration indicates that the SRS resource is configured with group hopping and sequence hopping. The transmission component 1204 may transmit an SRS in the SRS resource in accordance with the configuration of the SRS resource.

The selection component may select a group index value using group hopping and/or select a sequence index value using sequence hopping.

The reception component 1202 may receive an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource.

The transmission component 1204 may transmit the SRS in the SRS resources in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

The reception component 1202 may receive a configuration of parameters for an SRS resource of an SRS resource set. The reception component 1202 may receive a dynamic indication of an updated value for at least one of the parameters for the SRS resource. The transmission component 1204 may transmit an SRS in the SRS resource in accordance with the updated value for the at least one of the parameters for the SRS resource.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308. The communication manager 1308 may include a selection component 1310, among other examples.

In some aspects, the apparatus 1300 may be configured to perform one or more operations described herein in connection with FIGS. 6-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the base station described in connection with FIG. 2. The communication manager 1308 may be, or be similar to, the communication manager 150 depicted in FIGS. 1 and 2. For example, in some aspects, the communication manager 1308 may be configured to perform one or more of the functions described as being performed by the communication manager 150 depicted in FIGS. 1 and 2. In some aspects, the communication manager 1308 may include the reception component 1302 and/or the transmission component 1304.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The transmission component 1304 may transmit a configuration of an SRS resource for a UE, wherein the configuration indicates a sequence index value for a base sequence for the SRS resource or the configuration indicates that the SRS resource is configured with group hopping and sequence hopping. The reception component 1302 may receive an SRS in the SRS resource in accordance with the configuration of the SRS resource.

The selection component 1310 may select the sequence index value for the base sequence for the SRS resource or may select whether the SRS resource is configured with group hopping and sequence hopping.

The transmission component 1304 may transmit an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource.

The transmission component 1304 may transmit the SRS in the SRS resources in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

The transmission component 1304 may transmit a configuration of parameters for an SRS resource of an SRS resource set for a UE. The transmission component 1304 may transmit a dynamic indication of an updated value for at least one of the parameters for the SRS resource. The reception component 1302 may receive an SRS in the SRS resource in accordance with the updated value for the at least one of the parameters for the SRS resource.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a configuration of a sounding reference signal (SRS) resource, wherein the configuration indicates a sequence index value for a base sequence for the SRS resource or the configuration indicates that the SRS resource is configured with group hopping and sequence hopping; and transmitting an SRS in the SRS resource in accordance with the configuration of the SRS resource.

Aspect 2: The method of Aspect 1, wherein the configuration includes an indication of the sequence index value for the base sequence for the SRS resource.

Aspect 3: The method of Aspect 1, wherein the configuration includes an indication of a sequence identity of the SRS resource, and wherein the sequence identity of the SRS resource indicates the sequence index value for the base sequence for the SRS resource.

Aspect 4: The method of any of Aspects 1-3, wherein the configuration of the SRS resource is included in a configuration of an SRS resource set including a plurality of SRS resources, and wherein the configuration of the SRS resource set indicates a respective sequence index value for each SRS resource of the plurality of SRS resources.

Aspect 5: The method of any of Aspects 1-4, wherein the configuration indicates the sequence index value and a group index value for the base sequence for the SRS resource, and wherein transmitting the SRS in the SRS resource in accordance with the configuration of the SRS resource comprises: transmitting the SRS using a base sequence associated with the group index value and the sequence index value in all of one or more symbols in which the SRS resource is configured.

Aspect 6: The method of any of Aspects 1-4, wherein the configuration indicates the sequence index value for the base sequence for the SRS resource and the configuration indicates that group hopping is configured for the SRS resource, and wherein transmitting the SRS in the SRS resource in accordance with the configuration of the SRS resource comprises: transmitting the SRS, in each of one or more symbols in which the SRS resource is configured, using a respective base sequence associated with the sequence index value and a group index value selected using group hopping over a plurality of base sequence groups.

Aspect 7: The method of any of Aspects 1-4, wherein the configuration indicates the sequence index value for the base sequence for the SRS resource and the configuration indicates that sequence hopping is configured for the SRS resource, and wherein transmitting the SRS in the SRS resource in accordance with the configuration of the SRS resource comprises: transmitting the SRS, in each of one or more symbols in which the SRS resource is configured, using a respective base sequence selected using sequence hopping based at least in part on the sequence index value indicated by the configuration.

Aspect 8: The method of any of Aspects 1-4, wherein the configuration indicates that the SRS resource is configured with group hopping and sequence hopping, and wherein transmitting the SRS in the SRS resource in accordance with the configuration of the SRS resource comprises: transmitting the SRS, in each of one or more symbols in which the SRS resource is configured, using a respective base sequence associated with a group index value selected using group hopping in accordance with a pseudo-random sequence based at least in part on a slot number and a symbol number and a sequence index value selected using sequence hopping in accordance with the pseudo-random sequence based at least in part on the slot number and the symbol number.

Aspect 9: The method of Aspect 8, wherein the pseudo-random sequence is initialized every N radio frames, and wherein N is greater than 1.

Aspect 10: The method of Aspect 9, wherein N is indicated in the configuration or wherein N is based at least in part on a subcarrier spacing.

Aspect 11: The method of any of Aspects 1-4, wherein the configuration indicates that the SRS resource is configured with group hopping and sequence hopping, and wherein transmitting the SRS in the SRS resource in accordance with the configuration of the SRS resource comprises: transmitting the SRS, in each of one or more symbols in which the SRS resource is configured, using a respective base sequence associated with a group index value and a sequence index value, wherein the group index value and the sequence index value are determined based at least in part on a number generated in accordance with a pseudo-random sequence based at least in part on a slot number and a symbol number.

Aspect 12: The method of Aspect 11, wherein the pseudo-random sequence is initialized every N radio frames, and wherein N is greater than 1.

Aspect 13: The method of Aspect 12, wherein N is indicated in the configuration or wherein N is based at least in part on a subcarrier spacing.

Aspect 14: The method of any of Aspects 1-13, wherein the configuration indicates at least one of a comb spacing for the SRS resource, a comb offset for the SRS resource, a cyclic shift for the SRS resource, an SRS sequence identity for the SRS resource, a group index value for the base sequence for the SRS resource, or whether at least one of group hopping or sequence hopping is to be performed for the SRS resource.

Aspect 15: The method of Aspect 14, further comprising: receiving an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource.

Aspect 16: The method of Aspect 15, wherein transmitting the SRS in the SRS resource comprises: transmitting the SRS in the SRS resource in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

Aspect 17: The method of any of Aspects 15-16, wherein the indication is included in downlink control information (DCI) or a medium access control (MAC) control element (MAC-CE).

Aspect 18: The method of Aspect 17, wherein the indication is included in DCI that triggers one or more SRS resource sets.

Aspect 19: The method of Aspect 17, wherein the indication is included in a MAC-CE that activates a semi-persistent SRS resource set that includes the SRS resource.

Aspect 20: The method of any of Aspects 17-19, wherein two or more of the an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource are jointly coded into a bit field of the DCI or the MAC-CE.

Aspect 21: A method of wireless communication performed by a network entity, comprising: transmitting a configuration of a sounding reference signal (SRS) resource for a user equipment (UE), wherein the configuration indicates a sequence index value for a base sequence for the SRS resource or the configuration indicates that the SRS resource is configured with group hopping and sequence hopping; and receiving an SRS in the SRS resource in accordance with the configuration of the SRS resource.

Aspect 22: The method of Aspect 21, wherein the configuration includes an indication of the sequence index value for the base sequence for the SRS resource.

Aspect 23: The method of Aspect 21, wherein the configuration includes an indication of a sequence identity of the SRS resource, and wherein the sequence identity of the SRS resource indicates the sequence index value for the base sequence for the SRS resource.

Aspect 24: The method of any of Aspects 21-23, wherein the configuration of the SRS resource is included in a configuration of an SRS resource set including a plurality of SRS resources, and wherein the configuration of the SRS resource set indicates a respective sequence index value for each SRS resource of the plurality of SRS resources.

Aspect 25: The method of any of Aspects 21-24, wherein the configuration indicates the sequence index value and a group index value for the base sequence for the SRS resource, and wherein the configuration indicates that neither group hopping, nor sequence hopping, is configured for the SRS resource.

Aspect 26: The method of any of Aspects 21-24, wherein the configuration indicates the sequence index value for the base sequence for the SRS resource and the configuration indicates that group hopping is configured for the SRS resource.

Aspect 27: The method of any of Aspects 21-24, wherein the configuration indicates the sequence index value for the base sequence for the SRS resource and the configuration indicates that sequence hopping is configured for the SRS resource.

Aspect 28: The method of any of Aspects 21-24, wherein the configuration indicates that the SRS resource is configured with group hopping and sequence hopping.

Aspect 29: The method of Aspect 28, wherein the configuration indicates a number of frames associated with initializing a pseudo-random sequence for the group hopping and the sequence hopping, and wherein the number of frames is greater than 1.

Aspect 30: The method of any of Aspects 21-29, wherein the configuration indicates at least one of a comb spacing for the SRS resource, a comb offset for the SRS resource, a cyclic shift for the SRS resource, an SRS sequence identity for the SRS resource, a group index value for the base sequence for the SRS resource, or whether at least one of group hopping or sequence hopping is to be performed for the SRS resource.

Aspect 31: The method of Aspect 30, further comprising: transmitting an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource.

Aspect 32: The method of Aspect 31, wherein receiving the SRS in the SRS resource comprises: receiving the SRS in the SRS resource in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

Aspect 33: The method of any of Aspects 31-32, wherein the indication is included in downlink control information (DCI) or a medium access control (MAC) control element (MAC-CE).

Aspect 34: The method of Aspect 33, wherein the indication is included in DCI that triggers one or more SRS resource sets.

Aspect 35: The method of Aspect 33, wherein the indication is included in a MAC-CE that activates a semi-persistent SRS resource set that includes the SRS resource.

Aspect 36: The method of any of Aspects 33-35, wherein two or more of the an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource are jointly coded into a bit field of the DCI or the MAC-CE.

Aspect 37: A method of wireless communication performed by a user equipment (UE), comprising: receiving a configuration of parameters for a sounding reference signal (SRS) resource of an SRS resource set; receiving a dynamic indication of an updated value for at least one of the parameters for the SRS resource; and transmitting an SRS in the SRS resource in accordance with the updated value for the at least one of the parameters for the SRS resource.

Aspect 38: The method of Aspect 37, wherein the at least one of the parameters for the SRS resource includes at least one of a comb spacing parameter, a comb offset parameter, a cyclic shift parameter, an SRS sequence identity, a group index value, or a parameter that indicates whether at least one of group hopping or sequence hopping is to be performed for the SRS resource.

Aspect 39: The method of any of Aspects 37-38, wherein the dynamic indication is included in downlink control information (DCI) or a medium access control (MAC) control element (MAC-CE).

Aspect 40: The method of Aspect 39, wherein the indication is included in DCI that triggers one or more SRS resource sets.

Aspect 41: The method of Aspect 39, wherein the SRS resource set is a semi-persistent SRS resource set, and wherein the dynamic indication is included in a MAC-CE that activates the SRS resource set.

Aspect 42: The method of any of Aspects 39-41, wherein the dynamic indication includes an indication, in a bit field of the DCI or the MAC-CE, that is jointly coded to indicate updated values for two or more of the parameters for the SRS resource.

Aspect 43: A method of wireless communication performed by a network entity, comprising: transmitting a configuration of parameters for a sounding reference signal (SRS) resource of an SRS resource set for a user equipment (UE); transmitting a dynamic indication of an updated value for at least one of the parameters for the SRS resource; and receiving an SRS in the SRS resource in accordance with the updated value for the at least one of the parameters for the SRS resource.

Aspect 44: The method of Aspect 43, wherein the at least one of the parameters for the SRS resource includes at least one of a comb spacing parameter, a comb offset parameter, a cyclic shift parameter, an SRS sequence identity, a group index value, or a parameter that indicates whether at least one of group hopping or sequence hopping is to be performed for the SRS resource.

Aspect 45: The method of any of Aspects 43-44, wherein the dynamic indication is included in downlink control information (DCI) or a medium access control (MAC) control element (MAC-CE).

Aspect 46: The method of Aspect 45, wherein the indication is included in DCI that triggers one or more SRS resource sets.

Aspect 47: The method of Aspect 45, wherein the SRS resource set is a semi-persistent SRS resource set, and wherein the dynamic indication is included in a MAC-CE that activates the SRS resource set.

Aspect 48: The method of any of Aspects 45-47, wherein the dynamic indication includes an indication, in a bit field of the DCI or the MAC-CE, that is jointly coded to indicate updated values for two or more of the parameters for the SRS resource.

Aspect 49: An apparatus for wireless communication at a device, comprising a processor; memory coupled with the processor; and instructions stored in the memory and executable by the processor to cause the apparatus to perform the method of one or more of Aspects 1-20.

Aspect 50: A device for wireless communication, comprising a memory and one or more processors coupled to the memory, the one or more processors configured to perform the method of one or more of Aspects 1-20.

Aspect 51: An apparatus for wireless communication, comprising at least one means for performing the method of one or more of Aspects 1-20.

Aspect 52: A non-transitory computer-readable medium storing code for wireless communication, the code comprising instructions executable by a processor to perform the method of one or more of Aspects 1-20.

Aspect 53: A non-transitory computer-readable medium storing a set of instructions for wireless communication, the set of instructions comprising one or more instructions that, when executed by one or more processors of a device, cause the device to perform the method of one or more of Aspects 1-20.

Aspect 54: An apparatus for wireless communication at a device, comprising a processor; memory coupled with the processor; and instructions stored in the memory and executable by the processor to cause the apparatus to perform the method of one or more of Aspects 21-36.

Aspect 55: A device for wireless communication, comprising a memory and one or more processors coupled to the memory, the one or more processors configured to perform the method of one or more of Aspects 21-36.

Aspect 56: An apparatus for wireless communication, comprising at least one means for performing the method of one or more of Aspects 21-36.

Aspect 57: A non-transitory computer-readable medium storing code for wireless communication, the code comprising instructions executable by a processor to perform the method of one or more of Aspects 21-36.

Aspect 58: A non-transitory computer-readable medium storing a set of instructions for wireless communication, the set of instructions comprising one or more instructions that, when executed by one or more processors of a device, cause the device to perform the method of one or more of Aspects 21-36.

Aspect 59: An apparatus for wireless communication at a device, comprising a processor; memory coupled with the processor; and instructions stored in the memory and executable by the processor to cause the apparatus to perform the method of one or more of Aspects 37-42.

Aspect 60: A device for wireless communication, comprising a memory and one or more processors coupled to the memory, the one or more processors configured to perform the method of one or more of Aspects 37-42.

Aspect 61: An apparatus for wireless communication, comprising at least one means for performing the method of one or more of Aspects 37-42.

Aspect 62: A non-transitory computer-readable medium storing code for wireless communication, the code comprising instructions executable by a processor to perform the method of one or more of Aspects 37-42.

Aspect 63: A non-transitory computer-readable medium storing a set of instructions for wireless communication, the set of instructions comprising one or more instructions that, when executed by one or more processors of a device, cause the device to perform the method of one or more of Aspects 37-42.

Aspect 64: An apparatus for wireless communication at a device, comprising a processor; memory coupled with the processor; and instructions stored in the memory and executable by the processor to cause the apparatus to perform the method of one or more of Aspects 43-48.

Aspect 65: A device for wireless communication, comprising a memory and one or more processors coupled to the memory, the one or more processors configured to perform the method of one or more of Aspects 43-48.

Aspect 66: An apparatus for wireless communication, comprising at least one means for performing the method of one or more of Aspects 43-48.

Aspect 67: A non-transitory computer-readable medium storing code for wireless communication, the code comprising instructions executable by a processor to perform the method of one or more of Aspects 43-48.

Aspect 68: A non-transitory computer-readable medium storing a set of instructions for wireless communication, the set of instructions comprising one or more instructions that, when executed by one or more processors of a device, cause the device to perform the method of one or more of Aspects 43-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a configuration of a sounding reference signal (SRS) resource, wherein the configuration indicates a sequence index value for a base sequence for the SRS resource or the configuration indicates that the SRS resource is configured with group hopping and sequence hopping; and
transmit an SRS in the SRS resource in accordance with the configuration of the SRS resource.

2. The UE of claim 1, wherein the configuration includes an indication of the sequence index value for the base sequence for the SRS resource.

3. The UE of claim 1, wherein the configuration includes an indication of a sequence identity of the SRS resource, and wherein the sequence identity of the SRS resource indicates the sequence index value for the base sequence for the SRS resource.

4. The UE of claim 1, wherein the configuration of the SRS resource is included in a configuration of an SRS resource set including a plurality of SRS resources, and wherein the configuration of the SRS resource set indicates a respective sequence index value for each SRS resource of the plurality of SRS resources.

5. The UE of claim 1, wherein the configuration indicates the sequence index value and a group index value for the base sequence for the SRS resource, and wherein the one or more processors, to transmit the SRS in the SRS resource in accordance with the configuration of the SRS resource, are configured to:
transmit the SRS using a base sequence associated with the group index value and the sequence index value in all of one or more symbols in which the SRS resource is configured.

6. The UE of claim 1, wherein the configuration indicates the sequence index value for the base sequence for the SRS resource and the configuration indicates that group hopping is configured for the SRS resource, and wherein the one or more processors, to transmit the SRS in the SRS resource in accordance with the configuration of the SRS resource, are configured to:
transmit the SRS, in each of one or more symbols in which the SRS resource is configured, using a respective base sequence associated with the sequence index value and a group index value selected using group hopping over a plurality of base sequence groups.

7. The UE of claim 1, wherein the configuration indicates the sequence index value for the base sequence for the SRS resource and the configuration indicates that sequence hopping is configured for the SRS resource, and wherein the one or more processors, to transmit the SRS in the SRS resource in accordance with the configuration of the SRS resource, are configured to:
transmit the SRS, in each of one or more symbols in which the SRS resource is configured, using a respective base sequence selected using sequence hopping based at least in part on the sequence index value indicated by the configuration.

8. The UE of claim 1, wherein the configuration indicates that the SRS resource is configured with group hopping and sequence hopping, and wherein the one or more processors, to transmit the SRS in the SRS resource in accordance with the configuration of the SRS resource, are configured to:
transmit the SRS, in each of one or more symbols in which the SRS resource is configured, using a respective base sequence associated with a group index value selected using group hopping in accordance with a pseudo-random sequence based at least in part on a slot number and a symbol number and a sequence index value selected using sequence hopping in accordance with the pseudo-random sequence based at least in part on the slot number and the symbol number.

9. The UE of claim 8, wherein the pseudo-random sequence is initialized every N radio frames, wherein N is greater than 1, and wherein N is indicated in the configuration or N is based at least in part on a subcarrier spacing.

10. The UE of claim 1, wherein the configuration indicates that the SRS resource is configured with group hopping and sequence hopping, and wherein the one or more processors, to transmit the SRS in the SRS resource in accordance with the configuration of the SRS resource, are configured to:
transmit the SRS, in each of one or more symbols in which the SRS resource is configured, using a respective base sequence associated with a group index value and a sequence index value, wherein the group index value and the sequence index value are determined based at least in part on a number generated in accordance with a pseudo-random sequence based at least in part on a slot number and a symbol number.

11. The UE of claim 10, wherein the pseudo-random sequence is initialized every N radio frames, wherein N is greater than 1, and wherein N is indicated in the configuration or N is based at least in part on a subcarrier spacing.

12. The UE of claim 1, wherein the configuration indicates at least one of a comb spacing for the SRS resource, a comb offset for the SRS resource, a cyclic shift for the SRS resource, an SRS sequence identity for the SRS resource, a group index value for the base sequence for the SRS resource, or whether at least one of group hopping or sequence hopping is to be performed for the SRS resource;
wherein the one or more processors are further configured to:
receive an indication of at least one of an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource; and
wherein the one or more processors, to transmit the SRS in the SRS resource, are configured to:
transmit the SRS in the SRS resource in accordance with the at least one of the updated comb spacing for the SRS resource, the updated comb offset for the SRS resource, the updated cyclic shift for the SRS resource, the updated SRS sequence identity for the SRS resource, the updated group index value for the base sequence for the SRS resource, or the update as to whether at least one of group hopping or sequence hopping is to be performed for the SRS resource.

13. The UE of claim 12, wherein the indication is included in downlink control information (DCI) that triggers one or more SRS resource sets or a medium access control (MAC) control element (MAC-CE) that activates a semi-persistent SRS resource set that includes the SRS resource.

14. The UE of claim 13, wherein two or more of the an updated comb spacing for the SRS resource, an updated comb offset for the SRS resource, an updated cyclic shift for the SRS resource, an updated SRS sequence identity for the SRS resource, an updated group index value for the base sequence for the SRS resource, or an update as to whether at least one of group hopping or sequence hopping is to be performed for the SRS resource are jointly coded into a bit field of the DCI or the MAC-CE.

15. A network entity for wireless communication, comprising:
a memory; and
one or more processors, coupled to the memory, configured to:
transmit a configuration of a sounding reference signal (SRS) resource for a user equipment (UE), wherein the configuration indicates a sequence index value for a base sequence for the SRS resource or the configuration indicates that the SRS resource is configured with group hopping and sequence hopping; and
receive an SRS in the SRS resource in accordance with the configuration of the SRS resource.

16. The network entity of claim 15, wherein the configuration includes an indication of the sequence index value for the base sequence for the SRS resource.

17. The network entity of claim 15, wherein the configuration includes an indication of a sequence identity of the SRS resource, and wherein the sequence identity of the SRS resource indicates the sequence index value for the base sequence for the SRS resource.

18. The network entity of claim 15, wherein the configuration of the SRS resource is included in a configuration of an SRS resource set including a plurality of SRS resources, and wherein the configuration of the SRS resource set indicates a respective sequence index value for each SRS resource of the plurality of SRS resources.

19. The network entity of claim 15, wherein the configuration indicates the sequence index value and a group index value for the base sequence for the SRS resource, and wherein the configuration indicates that neither group hopping, nor sequence hopping, is configured for the SRS resource.

20. The network entity of claim 15, wherein the configuration indicates the sequence index value for the base sequence for the SRS resource and the configuration indicates that group hopping is configured for the SRS resource.

21. The network entity of claim 15, wherein the configuration indicates the sequence index value for the base sequence for the SRS resource and the configuration indicates that sequence hopping is configured for the SRS resource.

22. The network entity of claim 15, wherein the configuration indicates that the SRS resource is configured with group hopping and sequence hopping, wherein the configuration indicates a number of frames associated with initializing a pseudo-random sequence for the group hopping and the sequence hopping, and wherein the number of frames is greater than 1.

23. A method of wireless communication performed by a user equipment (UE), comprising:
receiving a configuration of a sounding reference signal (SRS) resource, wherein the configuration indicates a sequence index value for a base sequence for the SRS resource or the configuration indicates that the SRS resource is configured with group hopping and sequence hopping; and
transmitting an SRS in the SRS resource in accordance with the configuration of the SRS resource.

24. The method of claim 23, wherein the configuration includes an indication of the sequence index value for the base sequence for the SRS resource, or wherein the configuration includes an indication of a sequence identity of the SRS resource, and the sequence identity of the SRS resource indicates the sequence index value for the base sequence for the SRS resource.

25. The method of claim 23, wherein the configuration indicates the sequence index value and a group index value for the base sequence for the SRS resource, and wherein transmitting the SRS in the SRS resource in accordance with the configuration of the SRS resource comprises:
transmitting the SRS using a base sequence associated with the group index value and the sequence index value in all of one or more symbols in which the SRS resource is configured.

26. The method of claim 23, wherein the configuration indicates the sequence index value for the base sequence for the SRS resource and the configuration indicates that group hopping is configured for the SRS resource, and wherein transmitting the SRS in the SRS resource in accordance with the configuration of the SRS resource comprises:
transmitting the SRS, in each of one or more symbols in which the SRS resource is configured, using a respective base sequence associated with the sequence index value and a group index value selected using group hopping over a plurality of base sequence groups.

27. The method of claim 23, wherein the configuration indicates the sequence index value for the base sequence for the SRS resource and the configuration indicates that sequence hopping is configured for the SRS resource, and wherein transmitting the SRS in the SRS resource in accordance with the configuration of the SRS resource comprises:
transmitting the SRS, in each of one or more symbols in which the SRS resource is configured, using a respective base sequence selected using sequence hopping based at least in part on the sequence index value indicated by the configuration.

28. The method of claim 23, wherein the configuration indicates that the SRS resource is configured with group hopping and sequence hopping, and wherein transmitting the SRS in the SRS resource in accordance with the configuration of the SRS resource comprises:
transmitting the SRS, in each of one or more symbols in which the SRS resource is configured, using a respective base sequence associated with a group index value selected using group hopping in accordance with a pseudo-random sequence based at least in part on a slot number and a symbol number and a sequence index value selected using sequence hopping in accordance with the pseudo-random sequence based at least in part on the slot number and the symbol number, wherein the pseudo-random sequence is initialized every N radio frames, and wherein N is greater than 1.

29. The method of claim 23, wherein the configuration indicates that the SRS resource is configured with group hopping and sequence hopping, and wherein transmitting the SRS in the SRS resource in accordance with the configuration of the SRS resource comprises:
transmitting the SRS, in each of one or more symbols in which the SRS resource is configured, using a respective base sequence associated with a group index value and a sequence index value, wherein the group index value and the sequence index value are determined based at least in part on a number generated in accordance with a pseudo-random sequence based at least in part on a slot number and a symbol number, wherein the pseudo-random sequence is initialized every N radio frames, and wherein N is greater than 1.

30. A method of wireless communication performed by a network entity, comprising:
transmitting a configuration of a sounding reference signal (SRS) resource for a user equipment (UE), wherein the configuration indicates a sequence index value for a base sequence for the SRS resource or the configuration indicates that the SRS resource is configured with group hopping and sequence hopping; and
receiving an SRS in the SRS resource in accordance with the configuration of the SRS resource.
